(19) United States
(12) Patent Application Publication
(10) Pub. No.: US 2024/0373471 A1
(43) Pub. Date: Nov. 7, 2024

(54) CANDIDATE CELL CONFIGURATION FOR LOWER-LAYER TRIGGERED MOBILITY

(71) Applicant: QUALCOMM Incorporated, San Diego, CA (US)

(72) Inventors: Tianyang BAI, Mountain View, CA (US); Yan ZHOU, San Diego, CA (US); Jelena DAMNJANOVIC, Del Mar, CA (US)

(21) Appl. No.: 18/648,043

(22) Filed: Apr. 26, 2024

Related U.S. Application Data
(60) Provisional application No. 63/499,345, filed on May 1, 2023.

(51) Int. Cl. H04W 74/0833; H04W 74/00; H04W 74/08; H04W 76/20

(52) U.S. Cl. CPC H04W 74/0833; H04W 74/006; H04W 74/0891; H04W 76/20

(57) ABSTRACT

Various aspects of the present disclosure generally relate to wireless communication. In some aspects, a user equipment (UE) may receive, from a serving cell, a physical downlink control channel (PDCCH) order initiating a random access procedure in a candidate cell. The UE may determine a timing delay associated with a timing difference between the serving cell and the candidate cell. The UE may transmit a physical random access channel (PRACH) communication to the candidate cell in accordance with the PDCCH order and the timing delay. Numerous other aspects are described.

### CROSS-REFERENCE TO RELATED APPLICATION

This patent application claims priority to U.S. Provisional Patent Application No. 63/499,345, filed on May 1, 2023, entitled “PHYSICAL DOWNLINK CONTROL CHANNEL ORDER RECEPTION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses associated with a candidate cell configuration for lower-layer triggered mobility (LTM).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors may be configured to receive, from a serving cell, a physical downlink control channel (PDCCH) order initiating a random access procedure in a candidate cell. The one or more processors may be configured to determine a timing delay associated with a timing difference between the serving cell and the candidate cell. The one or more processors may be configured to transmit a physical random access channel (PRACH) communication to the candidate cell in accordance with the PDCCH order and the timing delay.

Some aspects described herein relate to an apparatus for wireless communication at a UE. The apparatus may include one or more memories and one or more processors coupled to the one or more memories. The one or more processors may be configured to receive a cell switch command, associated with a switch from a serving cell to a target cell, that indicates a unified transmission configuration indication (TCI) for the target cell. The one or more processors may be configured to obtain configuration information that indicates a beam to use for receiving or transmitting at least one channel or reference signal configured to not use the unified TCI. The one or more processors may be configured to communicate in the target cell in accordance with the configuration information.

Some aspects described herein relate to an apparatus for wireless communication at a UE. The apparatus may include one or more memories and one or more processors coupled to the one or more memories. The one or more processors may be configured to obtain configuration information associated with implicit TCI activation based at least in part on switching from a first cell to a second cell. The one or more processors may be configured to receive a cell switch command that includes an indication to switch from the first cell to the second cell. The one or more processors may be configured to activate a TCI for the second cell in accordance with the configuration information and the cell switch command.

Some aspects described herein relate to a method of wireless communication performed by a UE. The method may include receiving, from a serving cell, a PDCCH order initiating a random access procedure in a candidate cell. The method may include determining a timing delay associated with a timing difference between the serving cell and the candidate cell. The method may include transmitting a PRACH communication to the candidate cell in accordance with the PDCCH order and the timing delay.

Some aspects described herein relate to a method of wireless communication performed by a UE. The method may include receiving a cell switch command, associated with a switch from a serving cell to a target cell, that indicates a unified TCI for the target cell. The method may include obtaining configuration information that indicates a beam to use for receiving or transmitting at least one channel or reference signal configured to not use the unified TCI. The method may include communicating in the target cell in accordance with the configuration information.

Some aspects described herein relate to a method of wireless communication performed by a UE. The method may include obtaining configuration information associated with implicit TCI activation based at least in part on switching from a first cell to a second cell. The method may include receiving a cell switch command that includes an indication to switch from the first cell to the second cell. The method may include activating a TCI for the second cell in accordance with the configuration information and the cell switch command.

Some aspects described herein relate to a non-transitory computer-readable medium that stores a set of instructions for wireless communication by a UE. The set of instructions, when executed by one or more processors of the UE, may cause the UE to receive, from a serving cell, a PDCCH order initiating a random access procedure in a candidate cell. The set of instructions, when executed by one or more processors of the UE, may cause the UE to determine a timing delay associated with a timing difference between the serving cell and the candidate cell. The set of instructions, when executed by one or more processors of the UE, may cause the UE to transmit a PRACH communication to the candidate cell in accordance with the PDCCH order and the timing delay.

Some aspects described herein relate to a non-transitory computer-readable medium that stores a set of instructions for wireless communication by an UE. The set of instructions, when executed by one or more processors of the UE, may cause the UE to receive a cell switch command, associated with a switch from a serving cell to a target cell, that indicates a unified TCI for the target cell. The set of instructions, when executed by one or more processors of the UE, may cause the UE to obtain configuration information that indicates a beam to use for receiving or transmitting at least one channel or reference signal configured to not use the unified TCI. The set of instructions, when executed by one or more processors of the UE, may cause the UE to communicate in the target cell in accordance with the configuration information.

Some aspects described herein relate to a non-transitory computer-readable medium that stores a set of instructions for wireless communication by an UE. The set of instructions, when executed by one or more processors of the UE, may cause the UE to obtain configuration information associated with implicit TCI activation based at least in part on switching from a first cell to a second cell. The set of instructions, when executed by one or more processors of the UE, may cause the UE to receive a cell switch command that includes an indication to switch from the first cell to the second cell. The set of instructions, when executed by one or more processors of the UE, may cause the UE to activate a TCI for the second cell in accordance with the configuration information and the cell switch command.

Some aspects described herein relate to an apparatus for wireless communication. The apparatus may include means for receiving, from a serving cell, a PDCCH order initiating a random access procedure in a candidate cell. The apparatus may include means for determining a timing delay associated with a timing difference between the serving cell and the candidate cell. The apparatus may include means for transmitting a PRACH communication to the candidate cell in accordance with the PDCCH order and the timing delay.

Some aspects described herein relate to an apparatus for wireless communication. The apparatus may include means for receiving a cell switch command, associated with a switch from a serving cell to a target cell, that indicates a unified TCI for the target cell. The apparatus may include means for obtaining configuration information that indicates a beam to use for receiving or transmitting at least one channel or reference signal configured to not use the unified TCI. The apparatus may include means for communicating in the target cell in accordance with the configuration information.

Some aspects described herein relate to an apparatus for wireless communication. The apparatus may include means for obtaining configuration information associated with TCI activation based at least in part on switching from a first cell to a second cell. The apparatus may include means for receiving a cell switch command that includes an indication to switch from the first cell to the second cell. The apparatus may include means for activating a TCI for the second cell in accordance with the configuration information and the cell switch command.

Some aspects described herein relate to a method of wireless communication performed by a UE. The method may include obtaining an indication of a timing delay associated with PDCCH order reception from a serving cell and PRACH transmission to a candidate cell. The method may include communicating in accordance with the timing delay.

Some aspects described herein relate to a method of wireless communication performed by a network node. The method may include obtaining an indication of a timing delay associated with PDCCH order reception from a serving cell and PRACH transmission to a candidate cell. The method may include communicating in accordance with the timing delay.

Some aspects described herein relate to a method of wireless communication performed by a UE. The method may include obtaining an indication that at least one channel or reference signal for a target cell is to use a TCI that is not associated with a unified TCI. The method may include receiving a cell switch command, associated with a switch from a serving cell to the target cell, that indicates the unified TCI for the target cell. The method may include communicating in accordance with the cell switch command.

Some aspects described herein relate to a method of wireless communication performed by a network node. The method may include obtaining an indication that at least one channel or reference signal for a target cell is to use a TCI that is not associated with a unified TCI. The method may include transmitting a cell switch command, associated with a switch from a serving cell to the target cell, that indicates the unified TCI for the target cell. The method may include communicating in accordance with the cell switch command.

Some aspects described herein relate to a method of wireless communication performed by a UE. The method may include obtaining configuration information that indicates for the UE to perform implicit TCI activation based at least in part on switching from a first cell to a second cell. The method may include receiving a cell switch command that indicates for the UE to switch from the first cell to the second cell. The method may include activating a TCI in accordance with the configuration information and the cell switch command.

Some aspects described herein relate to a method of wireless communication performed by a network node. The method may include transmitting configuration information that indicates for a UE to perform implicit TCI activation based at least in part on switching from a first cell to a second cell. The method may include transmitting a cell switch command that indicates for the UE to switch from the first cell to the second cell.

Some aspects described herein relate to a method of wireless communication performed by a UE. The method may include receiving TCI activation information associated with a first cell. The method may include activating a TCI for the first cell in accordance with the TCI activation information. The method may include receiving, after activating the TCI for the first cell, a cell switch command that indicates for the UE to switch from a second cell to the first cell.

Some aspects described herein relate to a method of wireless communication performed by a network node. The method may include transmitting configuration information that indicates for a UE to activate a TCI for a first cell prior to receiving a cell switch command that indicates for the UE to switch from a second cell to the first cell. The method may include transmitting the cell switch command that indicates for the UE to switch from the second cell to the first cell.

Some aspects described herein relate to an apparatus for wireless communication at a UE. The apparatus may include a memory and one or more processors coupled to the memory. The one or more processors may be configured to obtain an indication of a timing delay associated with PDCCH order reception from a serving cell and PRACH transmission to a candidate cell. The one or more processors may be configured to communicate in accordance with the timing delay.

Some aspects described herein relate to an apparatus for wireless communication at a network node. The apparatus may include a memory and one or more processors coupled to the memory. The one or more processors may be configured to obtain an indication of a timing delay associated with PDCCH order reception from a serving cell and PRACH transmission to a candidate cell. The one or more processors may be configured to communicate in accordance with the timing delay.

Some aspects described herein relate to an apparatus for wireless communication at a UE. The apparatus may include a memory and one or more processors coupled to the memory. The one or more processors may be configured to obtain an indication that at least one channel or reference signal for a target cell is to use a TCI that is not associated with a unified TCI. The one or more processors may be configured to receive a cell switch command, associated with a switch from a serving cell to the target cell, that indicates the unified TCI for the target cell. The one or more processors may be configured to communicate in accordance with the cell switch command.

Some aspects described herein relate to an apparatus for wireless communication at a network node. The apparatus may include a memory and one or more processors coupled to the memory. The one or more processors may be configured to obtain an indication that at least one channel or reference signal for a target cell is to use a TCI that is not associated with a unified TCI. The one or more processors may be configured to transmit a cell switch command, associated with a switch from a serving cell to the target cell, that indicates the unified TCI for the target cell. The one or more processors may be configured to communicate in accordance with the cell switch command.

Some aspects described herein relate to an apparatus for wireless communication at a UE. The apparatus may include a memory and one or more processors coupled to the memory. The one or more processors may be configured to obtain configuration information that indicates for the UE to perform implicit TCI activation based at least in part on switching from a first cell to a second cell. The one or more processors may be configured to receive a cell switch command that indicates for the UE to switch from the first cell to the second cell. The one or more processors may be configured to activate a TCI in accordance with the configuration information and the cell switch command.

Some aspects described herein relate to an apparatus for wireless communication at a network node. The apparatus may include a memory and one or more processors coupled to the memory. The one or more processors may be configured to transmit configuration information that indicates for a UE to perform implicit TCI activation based at least in part on switching from a first cell to a second cell. The one or more processors may be configured to transmit a cell switch command that indicates for the UE to switch from the first cell to the second cell.

Some aspects described herein relate to an apparatus for wireless communication at a UE. The apparatus may include a memory and one or more processors coupled to the memory. The one or more processors may be configured to receive TCI activation information associated with a first cell. The one or more processors may be configured to activate a TCI for the first cell in accordance with the TCI activation information. The one or more processors may be configured to receive, after activating the TCI for the first cell, a cell switch command that indicates for the UE to switch from a second cell to the first cell.

Some aspects described herein relate to an apparatus for wireless communication at a network node. The apparatus may include a memory and one or more processors coupled to the memory. The one or more processors may be configured to transmit configuration information that indicates for a UE to activate a TCI for a first cell prior to receiving a cell switch command that indicates for the UE to switch from a second cell to the first cell. The one or more processors may be configured to transmit the cell switch command that indicates for the UE to switch from the second cell to the first cell.

Some aspects described herein relate to a non-transitory computer-readable medium that stores a set of instructions for wireless communication by a UE. The set of instructions, when executed by one or more processors of the UE, may cause the UE to obtain an indication of a timing delay associated with PDCCH order reception from a serving cell and PRACH transmission to a candidate cell. The set of instructions, when executed by one or more processors of the UE, may cause the UE to communicate in accordance with the timing delay.

Some aspects described herein relate to a non-transitory computer-readable medium that stores a set of instructions for wireless communication by a network node. The set of instructions, when executed by one or more processors of the network node, may cause the network node to obtain an indication of a timing delay associated with PDCCH order reception from a serving cell and PRACH transmission to a candidate cell. The set of instructions, when executed by one or more processors of the network node, may cause the network node to communicate in accordance with the timing delay.

Some aspects described herein relate to a non-transitory computer-readable medium that stores a set of instructions for wireless communication by a UE. The set of instructions, when executed by one or more processors of the UE, may cause the UE to obtain an indication that at least one channel or reference signal for a target cell is to use a TCI that is not associated with a unified TCI. The set of instructions, when executed by one or more processors of the UE, may cause the UE to receive a cell switch command, associated with a switch from a serving cell to the target cell, that indicates the unified TCI for the target cell. The set of instructions, when executed by one or more processors of the UE, may cause the UE to communicate in accordance with the cell switch command.

Some aspects described herein relate to a non-transitory computer-readable medium that stores a set of instructions for wireless communication by a network node. The set of instructions, when executed by one or more processors of the network node, may cause the network node to obtain an indication that at least one channel or reference signal for a target cell is to use a TCI that is not associated with a unified TCI. The set of instructions, when executed by one or more processors of the network node, may cause the network node to transmit a cell switch command, associated with a switch from a serving cell to the target cell, that indicates the unified TCI for the target cell. The set of instructions, when executed by one or more processors of the network node, may cause the network node to communicate in accordance with the cell switch command.

Some aspects described herein relate to a non-transitory computer-readable medium that stores a set of instructions for wireless communication by a UE. The set of instructions, when executed by one or more processors of the UE, may cause the UE to obtain configuration information that indicates for the UE to perform implicit TCI activation based at least in part on switching from a first cell to a second cell. The set of instructions, when executed by one or more processors of the UE, may cause the UE to receive a cell switch command that indicates for the UE to switch from the first cell to the second cell. The set of instructions, when executed by one or more processors of the UE, may cause the UE to activate a TCI in accordance with the configuration information and the cell switch command.

Some aspects described herein relate to a non-transitory computer-readable medium that stores a set of instructions for wireless communication by a network node. The set of instructions, when executed by one or more processors of the network node, may cause the network node to transmit configuration information that indicates for a UE to perform implicit TCI activation based at least in part on switching from a first cell to a second cell. The set of instructions, when executed by one or more processors of the network node, may cause the network node to transmit a cell switch command that indicates for the UE to switch from the first cell to the second cell.

Some aspects described herein relate to a non-transitory computer-readable medium that stores a set of instructions for wireless communication by a UE. The set of instructions, when executed by one or more processors of the UE, may cause the UE to receive TCI activation information associated with a first cell. The set of instructions, when executed by one or more processors of the UE, may cause the UE to activate a TCI for the first cell in accordance with the TCI activation information. The set of instructions, when executed by one or more processors of the UE, may cause the UE to receive, after activating the TCI for the first cell, a cell switch command that indicates for the UE to switch from a second cell to the first cell.

Some aspects described herein relate to a non-transitory computer-readable medium that stores a set of instructions for wireless communication by a network node. The set of instructions, when executed by one or more processors of the network node, may cause the network node to transmit configuration information that indicates for a UE to activate a TCI for a first cell prior to receiving a cell switch command that indicates for the UE to switch from a second cell to the first cell. The set of instructions, when executed by one or more processors of the network node, may cause the network node to transmit the cell switch command that indicates for the UE to switch from the second cell to the first cell.

Some aspects described herein relate to an apparatus for wireless communication. The apparatus may include means for obtaining an indication of a timing delay associated with PDCCH order reception from a serving cell and PRACH transmission to a candidate cell. The apparatus may include means for communicating in accordance with the timing delay.

Some aspects described herein relate to an apparatus for wireless communication. The apparatus may include means for obtaining an indication of a timing delay associated with PDCCH order reception from a serving cell and PRACH transmission to a candidate cell. The apparatus may include means for communicating in accordance with the timing delay.

Some aspects described herein relate to an apparatus for wireless communication. The apparatus may include means for obtaining an indication that at least one channel or reference signal for a target cell is to use a TCI that is not associated with a unified TCI. The apparatus may include means for receiving a cell switch command, associated with a switch from a serving cell to the target cell, that indicates the unified TCI for the target cell. The apparatus may include means for communicating in accordance with the cell switch command.

Some aspects described herein relate to an apparatus for wireless communication. The apparatus may include means for obtaining an indication that at least one channel or reference signal for a target cell is to use a TCI that is not associated with a unified TCI. The apparatus may include means for transmitting a cell switch command, associated with a switch from a serving cell to the target cell, that indicates the unified TCI for the target cell. The apparatus may include means for communicating in accordance with the cell switch command.

Some aspects described herein relate to an apparatus for wireless communication. The apparatus may include means for obtaining configuration information that indicates for the apparatus to perform implicit TCI activation based at least in part on switching from a first cell to a second cell. The apparatus may include means for receiving a cell switch command that indicates for the apparatus to switch from the first cell to the second cell. The apparatus may include means for activating a TCI in accordance with the configuration information and the cell switch command.

Some aspects described herein relate to an apparatus for wireless communication. The apparatus may include means for transmitting configuration information that indicates for a UE to perform implicit TCI activation based at least in part on switching from a first cell to a second cell. The apparatus may include means for transmitting a cell switch command that indicates for the UE to switch from the first cell to the second cell.

Some aspects described herein relate to an apparatus for wireless communication. The apparatus may include means for receiving TCI activation information associated with a first cell. The apparatus may include means for activating a TCI for the first cell in accordance with the TCI activation information. The apparatus may include means for receiving, after activating the TCI for the first cell, a cell switch command that indicates for the apparatus to switch from a second cell to the first cell.

Some aspects described herein relate to an apparatus for wireless communication. The apparatus may include means for transmitting configuration information that indicates for a UE to activate a TCI for a first cell prior to receiving a cell switch command that indicates for the UE to switch from a second cell to the first cell. The apparatus may include means for transmitting the cell switch command that indicates for the UE to switch from the second cell to the first cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating examples of random access procedures, in accordance with the present disclosure.

FIG. 5 is a diagram illustrating an example of a lower-layer triggered mobility (LTM) procedure, in accordance with the present disclosure.

FIGS. 6A-6B are diagram illustrating examples of a physical downlink control channel ordered random access procedure for a candidate cell, in accordance with the present disclosure.

FIG. 7 is a diagram illustrating an example of physical downlink control channel order reception, in accordance with the present disclosure.

FIG. 8 is a diagram illustrating an example of a unified transmission configuration indication (TCI), in accordance with the present disclosure.

FIG. 9 is a diagram illustrating an example of implicit TCI activation, in accordance with the present disclosure.

FIG. 10 is a diagram illustrating an example of UE capability for TCI activation, in accordance with the present disclosure.

FIGS. 11-14 are diagrams illustrating example processes performed, for example, by a UE, in accordance with the present disclosure.

FIG. 15 is a diagram illustrating an example process performed, for example, by a network node, in accordance with the present disclosure.

FIG. 16 is a diagram illustrating an example process performed, for example, by a UE, in accordance with the present disclosure.

FIG. 17 is a diagram illustrating an example process performed, for example, by a network node, in accordance with the present disclosure.

FIG. 18 is a diagram illustrating an example process performed, for example, by a UE, in accordance with the present disclosure.

FIG. 19 is a diagram illustrating an example process performed, for example, by a network node, in accordance with the present disclosure.

FIG. 20 is a diagram illustrating an example process performed, for example, by a UE, in accordance with the present disclosure.

FIG. 21 is a diagram illustrating an example process performed, for example, by a network node, in accordance with the present disclosure.

FIG. 22 is a diagram of an example apparatus for wireless communication, in accordance with the present disclosure.

FIG. 23 is a diagram of an example apparatus for wireless communication, in accordance with the present disclosure.

### DETAILED DESCRIPTION

To enhance multi-beam operation at higher carrier frequencies, a wireless network may support efficient (e.g., low latency and/or low overhead) downlink and/or uplink beam management operations to support Layer 1 and/or Layer 2 (L1/L2)—centric inter-cell mobility. For example, L1/L2 signaling may be referred to as “lower-layer” signaling and may be used to activate and/or deactivate candidate cells in a set of cells configured for lower-layer triggered mobility (LTM) and/or to provide reference signals for measurement by a user equipment (UE) (e.g., such that the UE may select a candidate beam as a target beam for a lower-layer handover operation). Accordingly, one goal for L1/L2-centric inter-cell mobility is to enable a UE to perform a cell switch via dynamic control signaling at lower layers (for example, downlink control information (DCI) for L1 signaling or a medium access control (MAC) control element (MAC-CE) for L2 signaling), rather than semi-static Layer 3 (L3) radio resource control (RRC) signaling, in order to reduce latency, reduce overhead, and/or otherwise increase efficiency of the cell switch.

For example, a UE may receive a MAC-CE that carries an LTM cell switch command, which may allow the UE to switch to a configured LTM target cell without having to perform a random access channel (RACH) procedure in the LTM target cell in cases where the LTM cell switch command includes a valid timing advance command, or a measured timing advance associated with the LTM target cell is available. Otherwise, the UE may perform a contention-free RACH procedure in the LTM target cell, which may start with a physical RACH (PRACH) preamble transmission in a RACH occasion (e.g., that is selected according to a synchronization signal block (SSB) index indicated in the LTM cell switch command). Furthermore, the UE may communicate with the LTM target cell using a transmission configuration indication (TCI) state indicated in the LTM cell switch command.

In some cases, a UE may receive a PDCCH order from a first cell, such as a serving cell, and may transmit a PRACH transmission to a second cell, such as an LTM candidate cell. The PDCCH order may trigger a RACH procedure, such as for contention-free random access, and the PRACH may carry a random access preamble to assist with uplink timing. The UE may be configured to determine a latency value associated with PDCCH order triggering. However, the latency value may not include any additional delays resulting from a difference in a downlink transmission timing and/or a downlink reception timing between the serving cell and the candidate cell. This may result in the UE receiving the PDCCH order at a time that is different from a time indicated by the latency value and/or transmitting the PRACH at a time that is different from a time indicated by the latency value. Furthermore, in some cases, a cell switch command (CSC) may indicate for a UE to switch from a first cell to a second cell (e.g., to switch from communicating with a current cell to communicating with a target cell). The cell switch command may indicate a unified TCI for the target cell. However, some channels or reference signals used for communicating with the target cell may not be configured to follow the unified TCI. This may result in the UE not being able to determine TCI or beam information for communicating with the target cell. In some cases, activating TCI for a candidate cell may require a transmission of one or more communications to a UE. For example, a serving cell and/or a candidate cell may transmit separate communications to the UE to indicate the TCI for the candidate cell and/or to activate the TCI for the candidate cell. This may result in increased system overhead.

Various aspects generally relate to wireless communications and, for example, to a candidate cell configuration for LTM. In some examples, a UE may obtain an indication of a timing delay associated with a PDCCH order reception from a serving cell and a PRACH transmission to a candidate cell, and may communicate in accordance with the timing delay. The timing delay may be associated, for example, with a time delta between the serving cell and the candidate cell. In some examples, the UE may obtain an indication that at least one channel or reference signal for a target cell is to use a TCI that is not associated with a unified TCI. The UE may receive a cell switch command, associated with a switch from a serving cell to the target cell, that indicates a unified TCI for the target cell, and may communicate in accordance with the cell switch command. In one example, the UE may obtain an indication that all channels and reference signals used for communicating with the target cell are to use the unified TCI, and the cell switch command may include a single unified TCI or a single beam indication for the target cell. In another example, the UE may obtain an indication that a first channel or reference signal is to use the unified TCI and a second channel or reference signal is to use the TCI that is not associated with the unified TCI. In some examples, the UE may obtain configuration information that indicates for the UE to perform implicit TCI activation based at least in part on switching from a first cell to a second cell. The UE may receive a cell switch command that indicates for the UE to switch from the first cell to the second cell, and may implicitly activate the TCI in accordance with the configuration information and the cell switch command. In some examples, the UE may receive TCI activation information associated with a candidate cell, and may activate a TCI for the candidate cell in accordance with the TCI activation information. The UE may receive, after activating the TCI for the candidate cell, a cell switch command that indicates for the UE to switch from a serving cell to the candidate cell.

Particular aspects of the subject matter described in this disclosure can be implemented to realize one or more of the following potential advantages. In some examples, by obtaining the indication of the time delay, the described techniques can be used to more accurately calculate a latency value associated with receiving the PDCCH order. In some examples, by obtaining the indication that some or all channels and reference signals used for communicating with the second cell are to use the unified TCI, the described techniques can be used to more accurately determine TCI or beam information for communicating with a target cell. In some examples, by enabling the implicit TCI activation, the described techniques can be used to reduce network overhead. These example advantages, and other example advantages, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

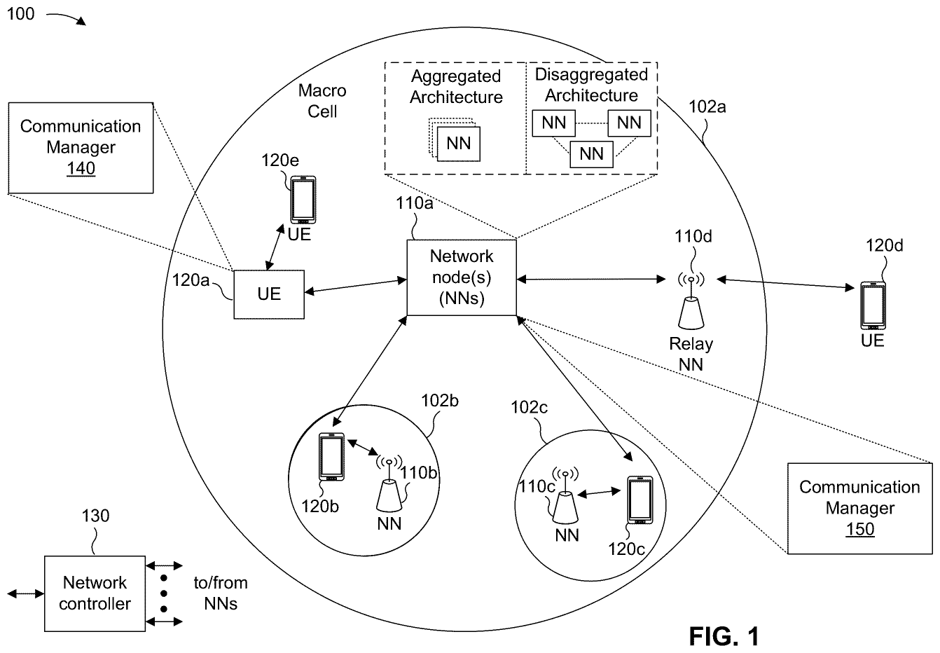

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a serving cell, a PDCCH order initiating a random access procedure in a candidate cell; determine a timing delay associated with a timing difference between the serving cell and the candidate cell; and transmit a PRACH communication to the candidate cell in accordance with the PDCCH order and the timing delay.

In some aspects, the communication manager 140 may receive a cell switch command, associated with a switch from a serving cell to a target cell, that indicates a unified TCI for the target cell; obtain configuration information that indicates a beam to use for receiving or transmitting at least one channel or reference signal configured to not use the unified TCI; and communicate in the target cell in accordance with the configuration information.

In some aspects, the communication manager 140 may obtain configuration information associated with implicit TCI activation based at least in part on switching from a first cell to a second cell; receive a cell switch command that includes an indication to switch from the first cell to the second cell; and activate a TCI for the second cell in accordance with the configuration information and the cell switch command.

In some aspects, the communication manager 140 may obtain an indication of a timing delay associated with PDCCH order reception from a serving cell and PRACH transmission to a candidate cell; and communicate in accordance with the timing delay.

In some aspects, the communication manager 140 may obtain an indication that at least one channel or reference signal for a target cell is to use a TCI that is not associated with a unified TCI; receive a cell switch command, associated with a switch from a serving cell to the target cell, that indicates the unified TCI for the target cell; and communicate in accordance with the cell switch command.

In some aspects, the communication manager 140 may obtain configuration information that indicates for the UE to perform implicit TCI activation based at least in part on switching from a first cell to a second cell; receive a cell switch command that indicates for the UE to switch from the first cell to the second cell; and activate a TCI in accordance with the configuration information and the cell switch command.

In some aspects, the communication manager 140 may receive TCI activation information associated with a first cell; activate a TCI for the first cell in accordance with the TCI activation information; and receive, after activating the TCI for the first cell, a cell switch command that indicates for the UE to switch from a second cell to the first cell.

Additionally, or alternatively, the communication manager 140 may perform one or more other operations described herein.

In some aspects, the network node 110 may include a communication manager 150. As described in more detail elsewhere herein, the communication manager 150 may obtain an indication of a timing delay associated with PDCCH order reception from a serving cell and PRACH transmission to a candidate cell; and communicate in accordance with the timing delay.

In some aspects, the communication manager 150 may obtain an indication that at least one channel or reference signal for a target cell is to use a TCI that is not associated with a unified TCI; transmit a cell switch command, associated with a switch from a serving cell to the target cell, that indicates the unified TCI for the target cell; and communicate in accordance with the cell switch command.

In some aspects, the communication manager 150 may transmit configuration information that indicates for a UE to perform implicit TCI activation based at least in part on switching from a first cell to a second cell; and transmit a cell switch command that indicates for the UE to switch from the first cell to the second cell.

In some aspects, the communication manager 150 may transmit configuration information that indicates for a UE to activate a TCI for a first cell prior to receiving a cell switch command that indicates for the UE to switch from a second cell to the first cell; and transmit the cell switch command that indicates for the UE to switch from the second cell to the first cell.

Additionally, or alternatively, the communication manager 150 may perform one or more other operations described herein.

As indicated above, FIG. 1 is provided as an example. Other examples may differ from what is described with regard to FIG. 1.

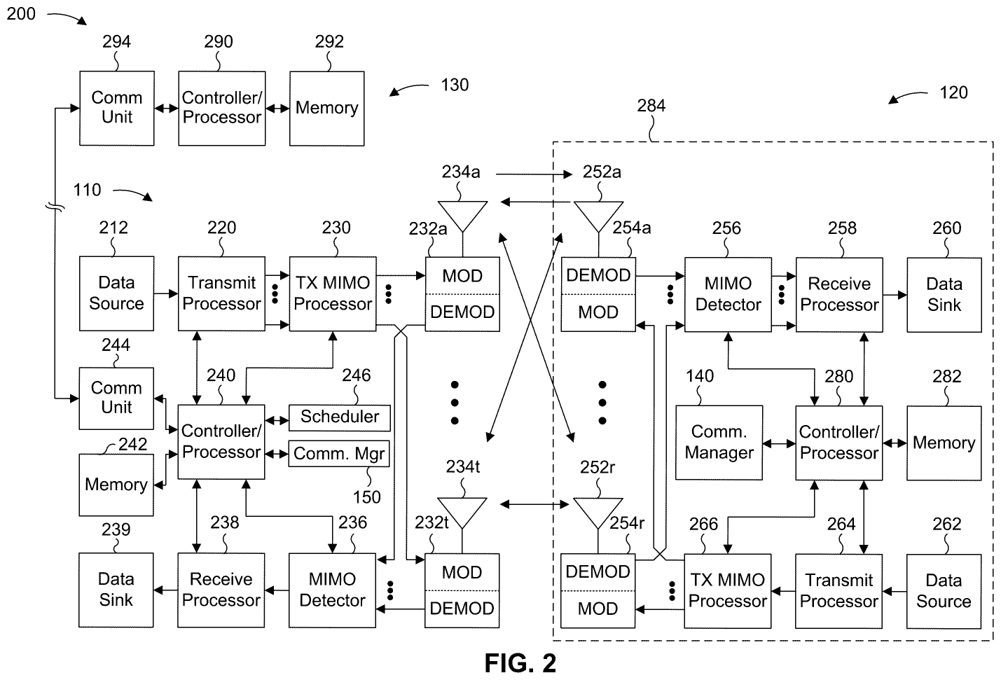

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

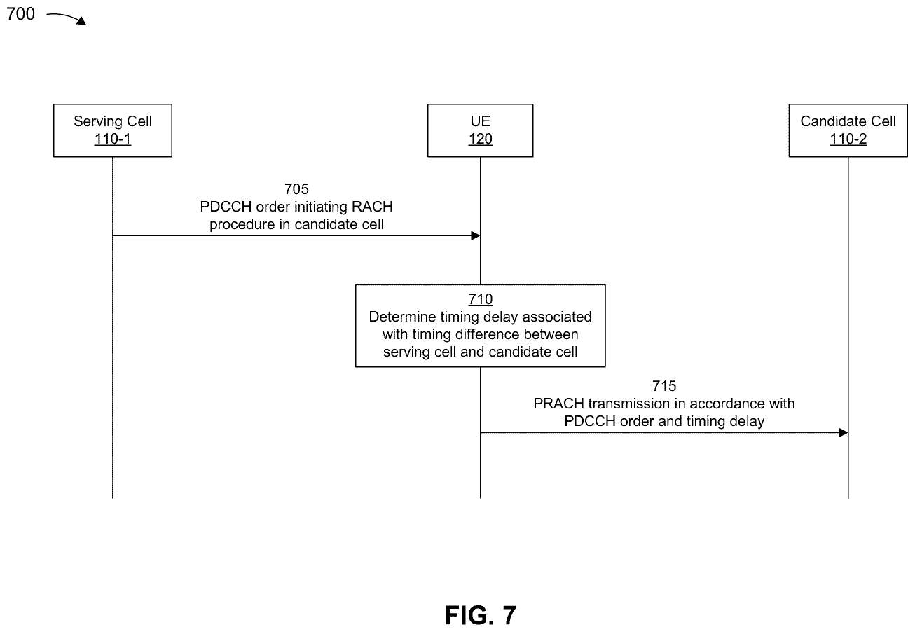

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-23).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-23).

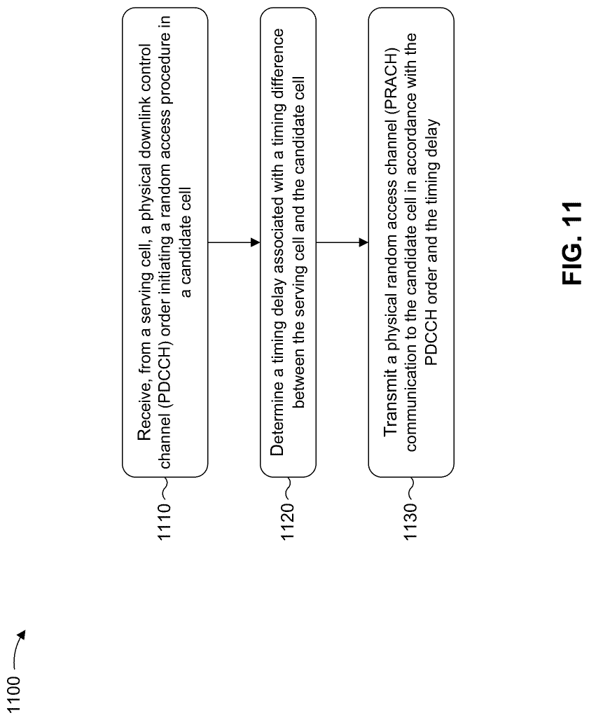

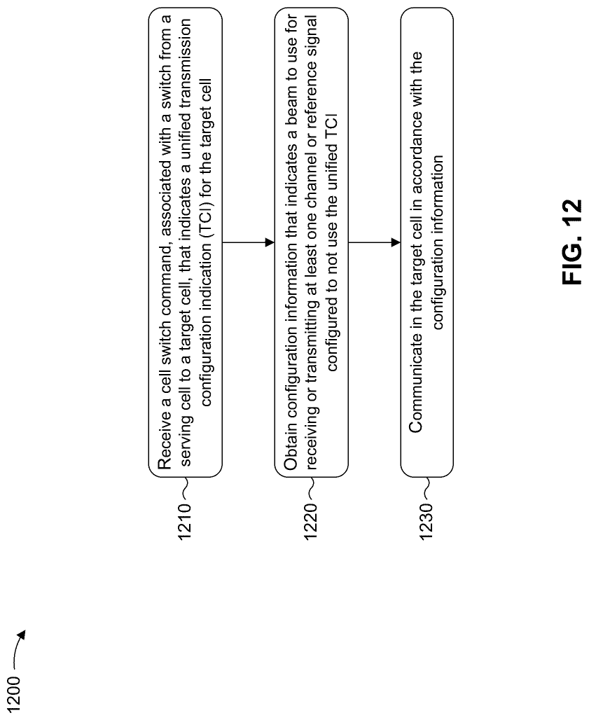

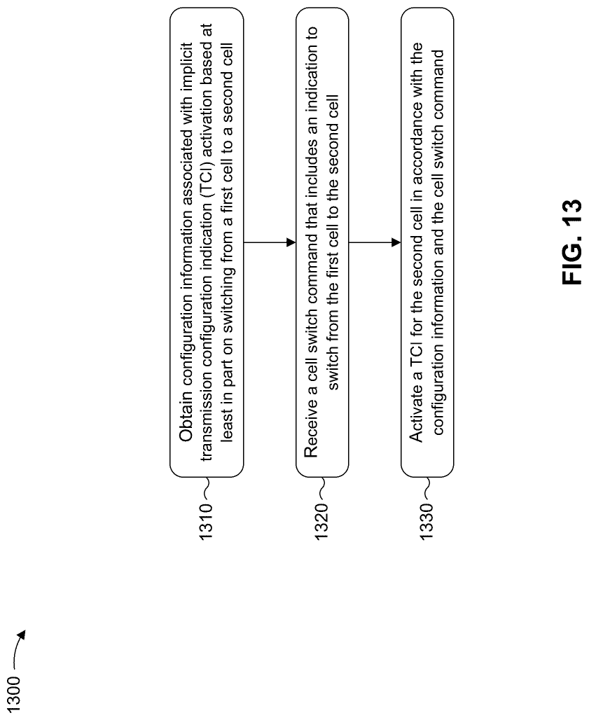

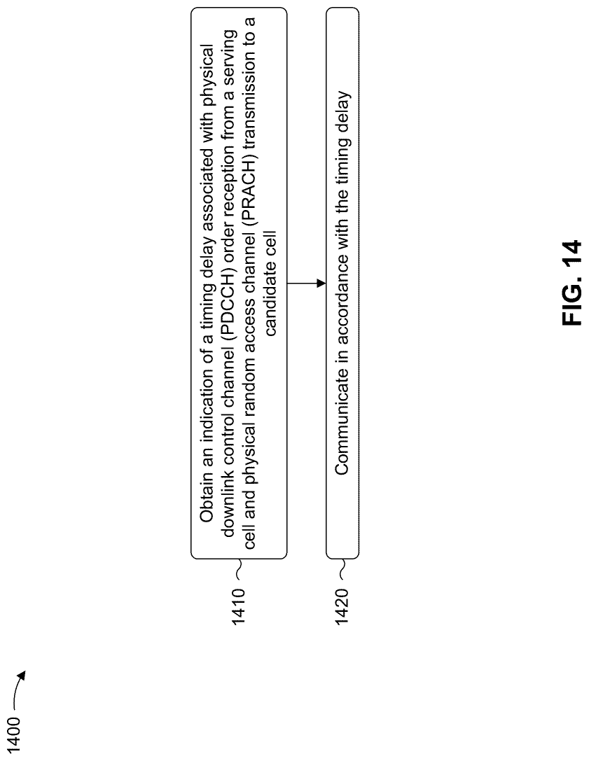

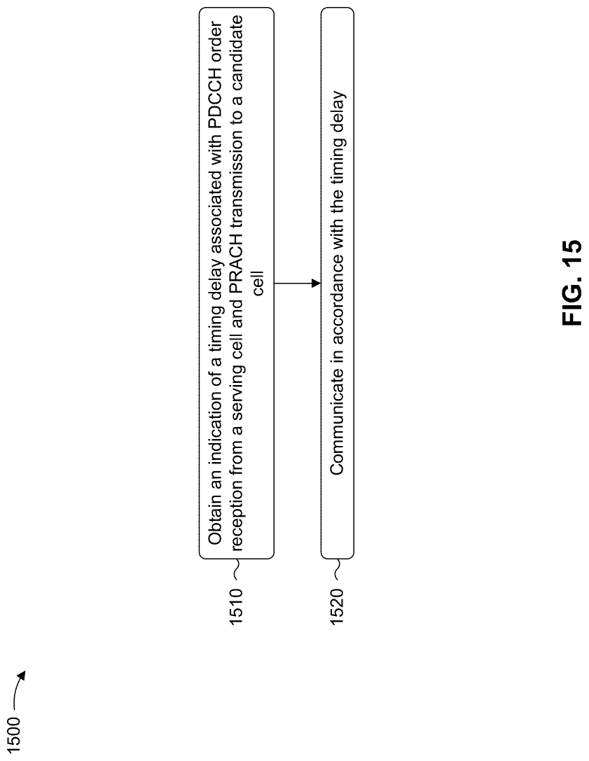

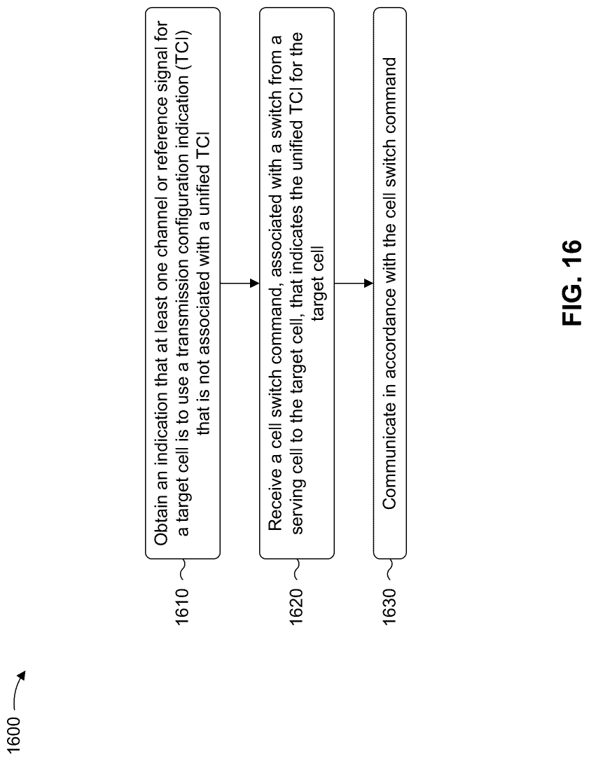

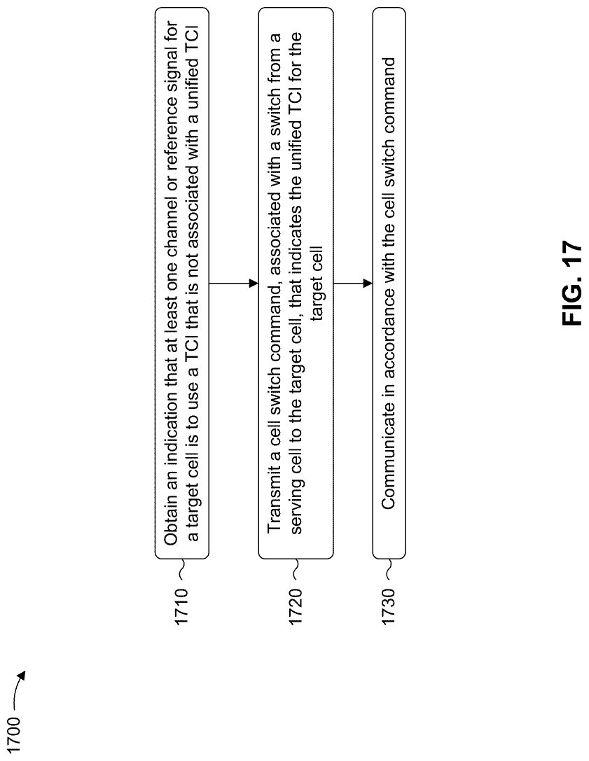

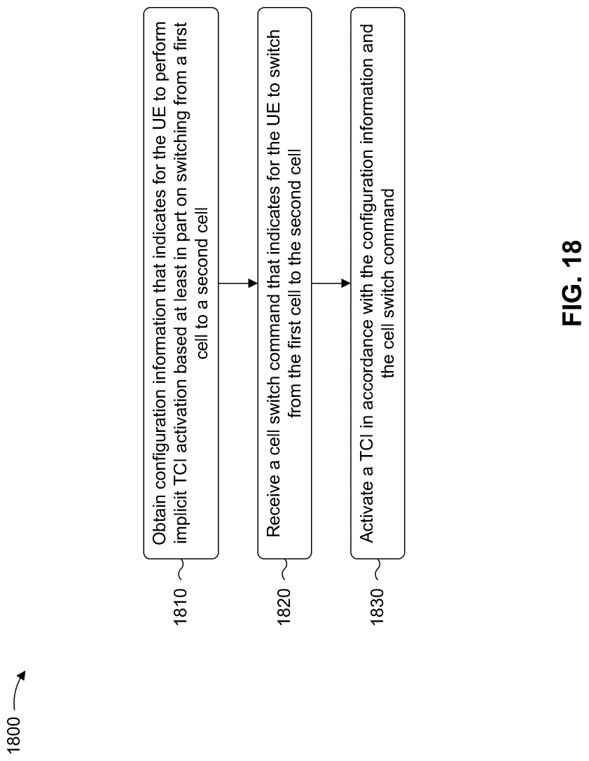

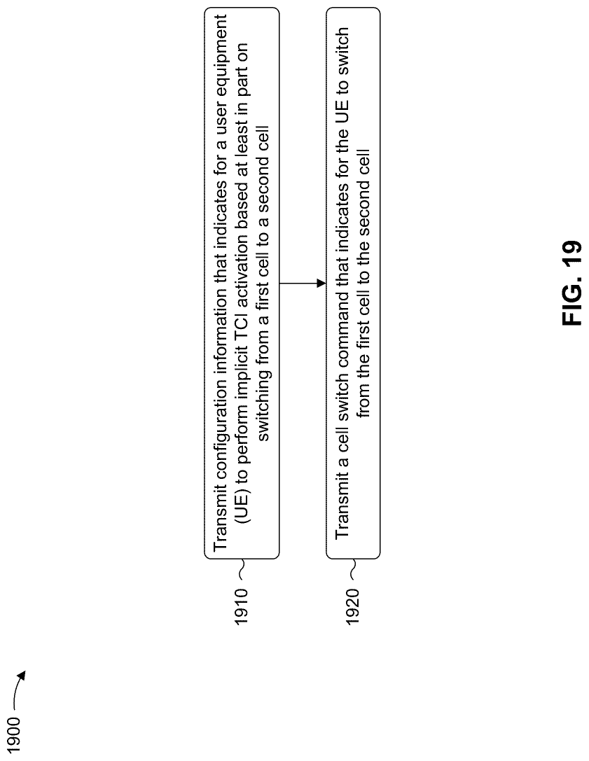

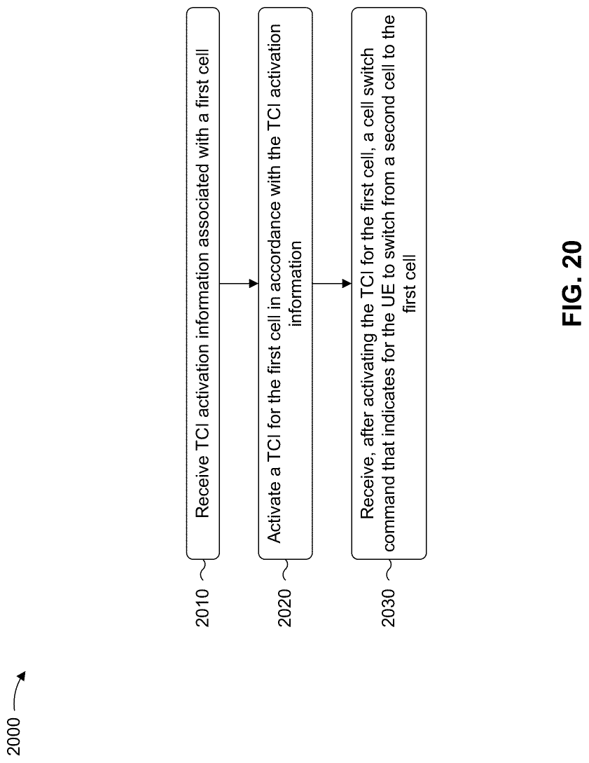

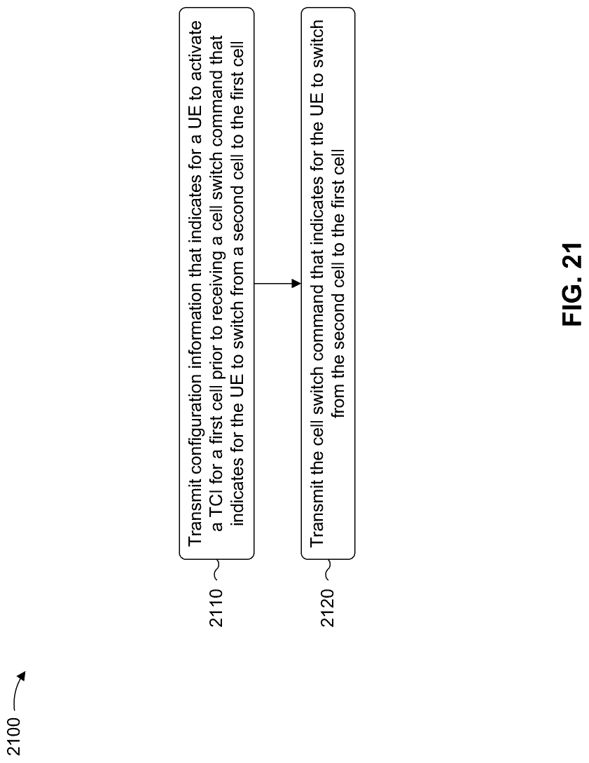

The controller/processor 240 of the network node 110, the controller/processor 280 of the UE 120, and/or any other component(s) of FIG. 2 may perform one or more techniques associated with a candidate cell configuration for LTM, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, and/or other processes as described herein. In some examples, executing instructions may include running the instructions, converting the instructions, compiling the instructions, and/or interpreting the instructions, among other examples.

In some aspects, the UE 120 includes means for receiving, from a serving cell, a PDCCH order initiating a random access procedure in a candidate cell; means for determining a timing delay associated with a timing difference between the serving cell and the candidate cell; and/or means for transmitting a PRACH communication to the candidate cell in accordance with the PDCCH order and the timing delay.

In some aspects, the UE 120 includes means for receiving a cell switch command, associated with a switch from a serving cell to a target cell, that indicates a unified TCI for the target cell; means for obtaining configuration information that indicates a beam to use for receiving or transmitting at least one channel or reference signal configured to not use the unified TCI; and/or means for communicating in the target cell in accordance with the configuration information.

In some aspects, the UE 120 includes means for obtaining configuration information associated with implicit TCI activation based at least in part on switching from a first cell to a second cell; means for receiving a cell switch command that includes an indication to switch from the first cell to the second cell; and/or means for activating a TCI for the second cell in accordance with the configuration information and the cell switch command.

In some aspects, the UE 120 includes means for obtaining an indication of a timing delay associated with PDCCH order reception from a serving cell and PRACH transmission to a candidate cell; and/or means for communicating in accordance with the timing delay.

In some aspects, the UE 120 includes means for obtaining an indication that at least one channel or reference signal for a target cell is to use a TCI that is not associated with a unified TCI; means for receiving a cell switch command, associated with a switch from a serving cell to the target cell, that indicates the unified TCI for the target cell; and/or means for communicating in accordance with the cell switch command.

In some aspects, the UE 120 includes means for obtaining configuration information that indicates for the UE to perform implicit TCI activation based at least in part on switching from a first cell to a second cell; means for receiving a cell switch command that indicates for the UE to switch from the first cell to the second cell; and/or means for activating a TCI in accordance with the configuration information and the cell switch command.

In some aspects, the UE 120 includes means for receiving TCI activation information associated with a first cell; means for activating a TCI for the first cell in accordance with the TCI activation information; and/or means for receiving, after activating the TCI for the first cell, a cell switch command that indicates for the UE to switch from a second cell to the first cell.

The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining an indication of a timing delay associated with PDCCH order reception from a serving cell and PRACH transmission to a candidate cell; and/or means for communicating in accordance with the timing delay.

In some aspects, the network node 110 includes means for obtaining an indication that at least one channel or reference signal for a target cell is to use a TCI that is not associated with a unified TCI; means for transmitting a cell switch command, associated with a switch from a serving cell to the target cell, that indicates the unified TCI for the target cell; and/or means for communicating in accordance with the cell switch command.

In some aspects, the network node 110 includes means for transmitting configuration information that indicates for a UE to perform implicit TCI activation based at least in part on switching from a first cell to a second cell; and/or means for transmitting a cell switch command that indicates for the UE to switch from the first cell to the second cell.

In some aspects, the network node 110 includes means for transmitting configuration information that indicates for a UE to activate a TCI for a first cell prior to receiving a cell switch command that indicates for the UE to switch from a second cell to the first cell; and/or means for transmitting the cell switch command that indicates for the UE to switch from the second cell to the first cell.

The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

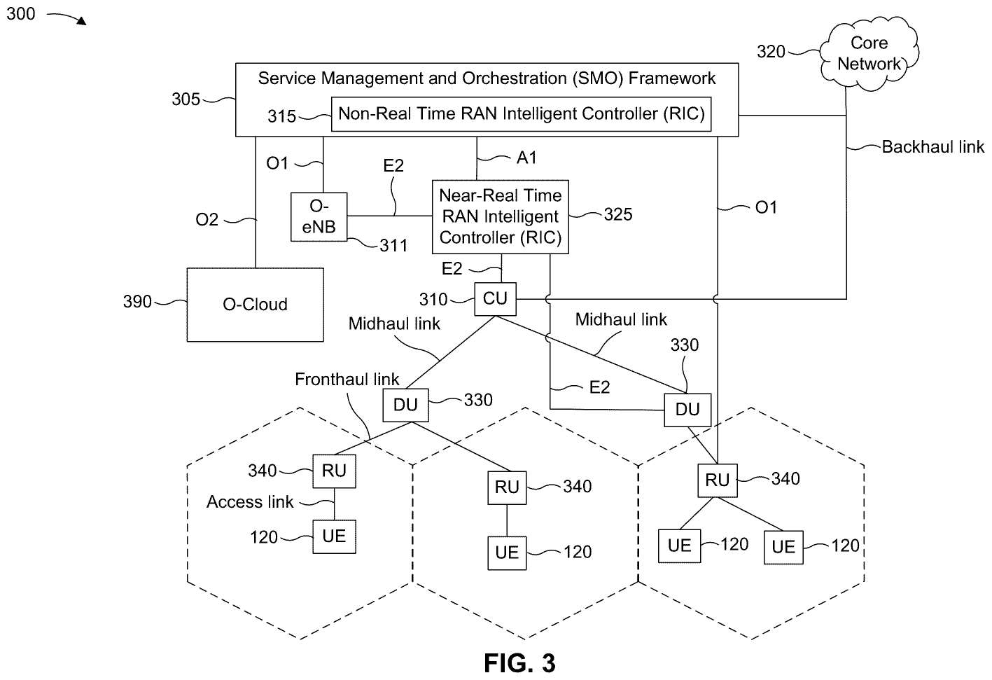

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

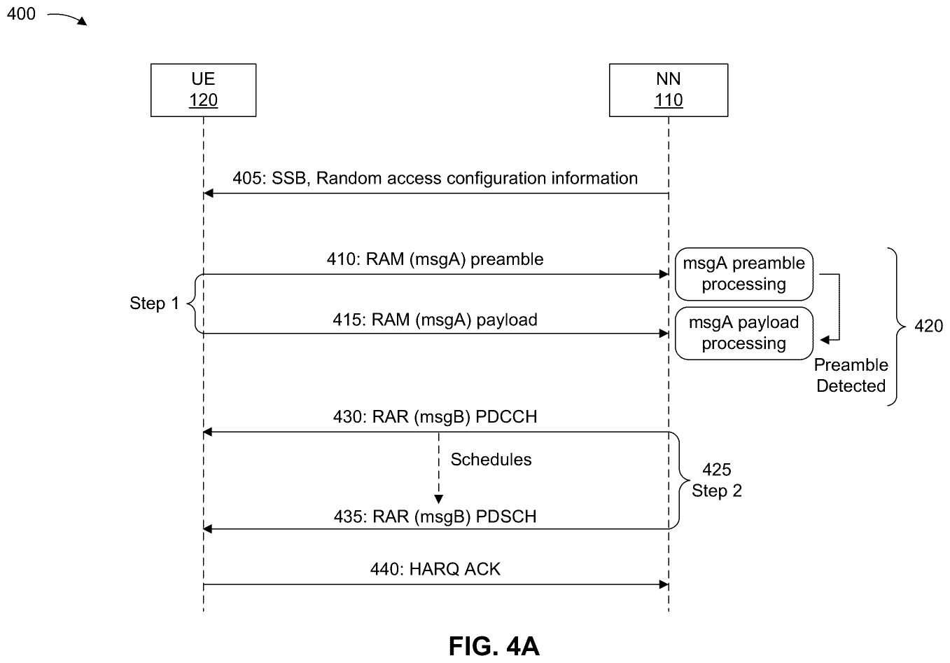

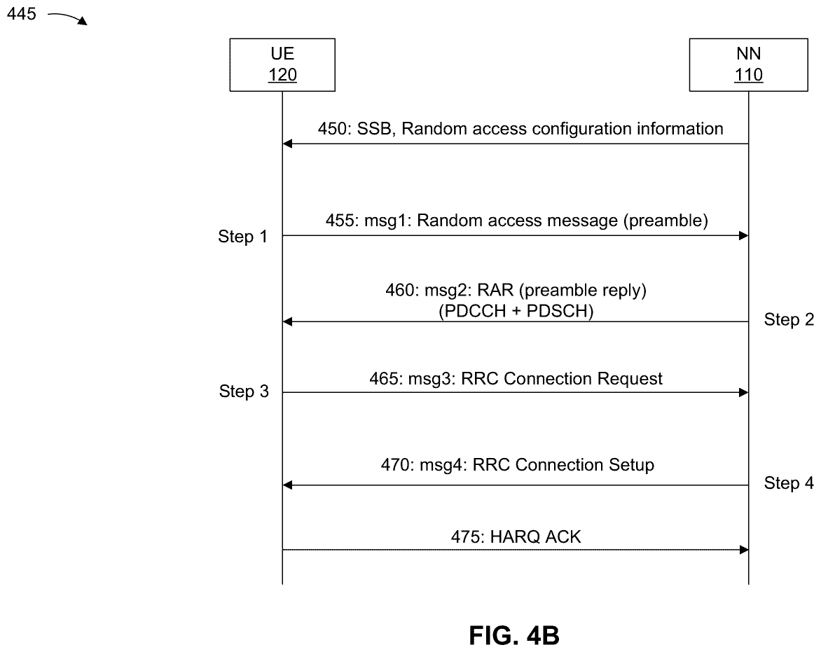

FIGS. 4A-4B are diagrams illustrating examples of random access procedures, in accordance with the present disclosure. A network node 110 and a UE 120 may communicate with one another to perform the random access procedures.

As shown in FIG. 4A and the example 400, in some aspects, the random access procedure may be a two-step random access procedure.

As shown by reference number 405, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message (such as PDCCH order DCI) that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 410, the UE 120 may transmit, and the network node 110 may receive, a RAM preamble. As shown by reference number 415, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

As shown by reference number 420, the network node 110 may receive the RAM preamble transmitted by the UE 120. If the network node 110 successfully receives and decodes the RAM preamble, the network node 110 may then receive and decode the RAM payload.

As shown by reference number 425, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 430, as part of the second step of the two-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation (e.g., in DCI) for the PDSCH communication.

As shown by reference number 435, as part of the second step of the two-step random access procedure, the network node 110 may transmit the PDSCH communication for the RAR, as scheduled by the PDCCH communication. The RAR may be included in a MAC protocol data unit (PDU) of the PDSCH communication. As shown by reference number 440, if the UE 120 successfully receives the RAR, the UE 120 may transmit a hybrid automatic repeat request (HARQ) acknowledgement (ACK).

As shown in FIG. 4B and the example 445, in some aspects, the random access procedure may be a four-step random access procedure.

As shown by reference number 450, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message (such as PDCCH order DCI) that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 455, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 460, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 465, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 470, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 475, if the UE 120 successfully receives the RRC connection setup message, the UE 120 may transmit a HARQ ACK.

As indicated above, FIGS. 4A-4B are provided as examples. Other examples may differ from what is described with regard to FIGS. 4A-4B.

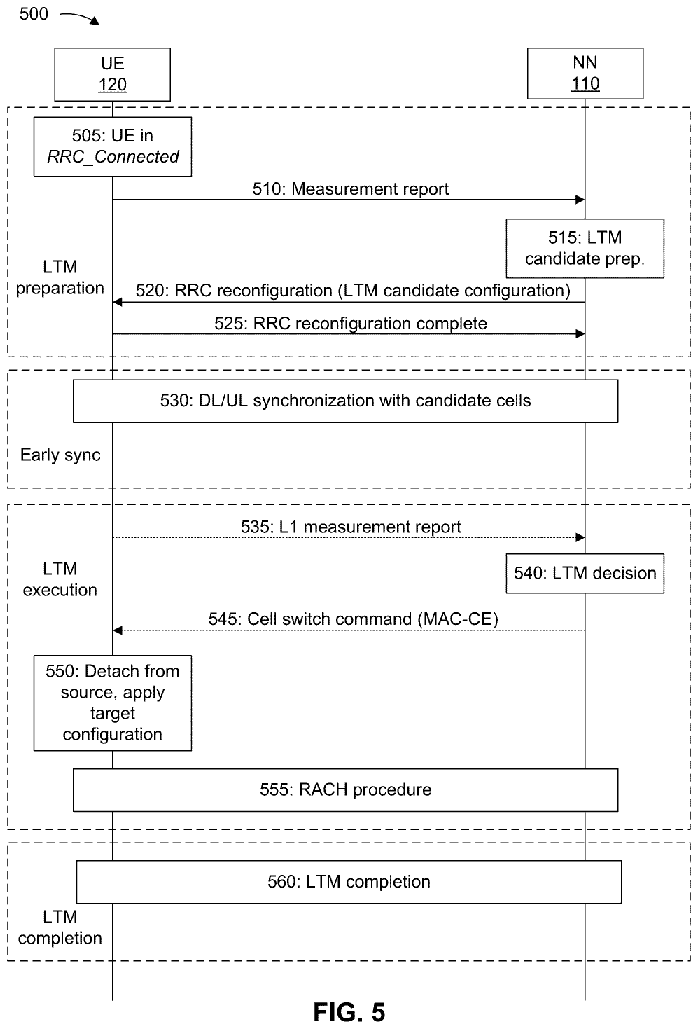

FIG. 5 is a diagram illustrating an example 500 of an LTM procedure, in accordance with the present disclosure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using an L3 handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the example 500 LTM procedure shown in FIG. 5. As shown in FIG. 5, the LTM procedure may include an LTM preparation phase, an early synchronization phase (shown as “early sync” in FIG. 5), an LTM execution phase, and/or an LTM completion phase.

During the LTM preparation phase, and as shown by reference number 505, the UE 120 may be in an RRC connected state (sometimes referred to as RRC_Connected) with a source cell. As shown by reference number 510, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. In some examples, based at least in part on the measurement report or other information, the network node 110 may decide to use LTM, and thus, as shown by reference number 515, the network node 110 may initiate LTM candidate preparation.

As shown by reference number 520, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate cells, which may be candidate cells to become a serving cell of the UE and/or cells for which the UE 120 may later be triggered to perform an LTM procedure. As shown by reference number 525, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 530, the UE 120 may optionally perform downlink and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 555.

During the LTM execution phase, and as shown by reference number 535, the UE 120 may perform L1 measurements on the configured LTM candidate cells, and thus may transmit, to the network node 110, L1 measurement reports. As shown by reference number 540, based at least in part on the lower-layer measurement reports, the network node 110 may decide to execute an LTM cell switch to an LTM target cell. Accordingly, as shown by reference number 545, the network node 110 may transmit, and the UE 120 may receive, a MAC-CE or similar message triggering an LTM cell switch (the MAC-CE or similar message is sometimes referred to herein as a cell switch command, an LTM cell switch command MAC-CE, a MAC-CE carrying a cell switch command, or the like). The cell switch command may include an indication of a candidate configuration index associated with the LTM target cell. As shown by reference number 550, based at least in part on receiving the cell switch command, the UE 120 may switch to the configuration of the LTM target cell (e.g., the UE 120 may detach from the source cell and apply the configuration of the LTM target cell). Moreover, as shown by reference number 555, the UE 120 may perform a RACH procedure towards the LTM target cell, such as when a timing advance associated with the target cell is not available (e.g., in examples in which the UE 120 did not perform the early synchronization as described above in connection with reference number 530 and/or the LTM cell switch command does not indicate a valid timing advance for the LTM target cell).

During the LTM completion phase, and as shown by reference number 560, the UE 120 may indicate successful completion of the LTM cell switch towards the LTM target cell. In this way, a cell switch or handover to a target cell may be performed using less overhead than an L3 handover procedure and/or a reduced latency relative to an L3 handover procedure.

As indicated above, FIG. 5 is provided as an example. Other examples may differ from what is described with respect to FIG. 5.

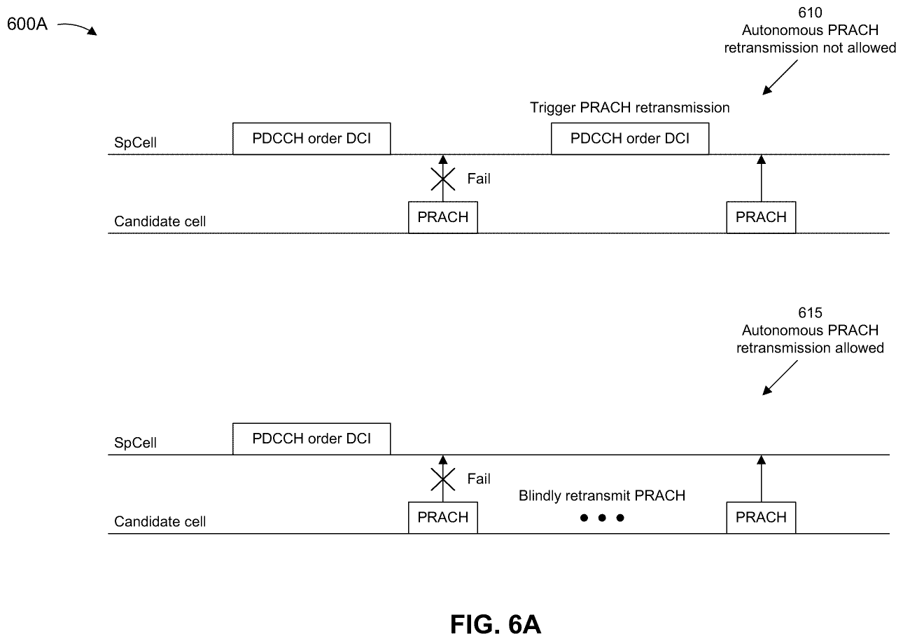

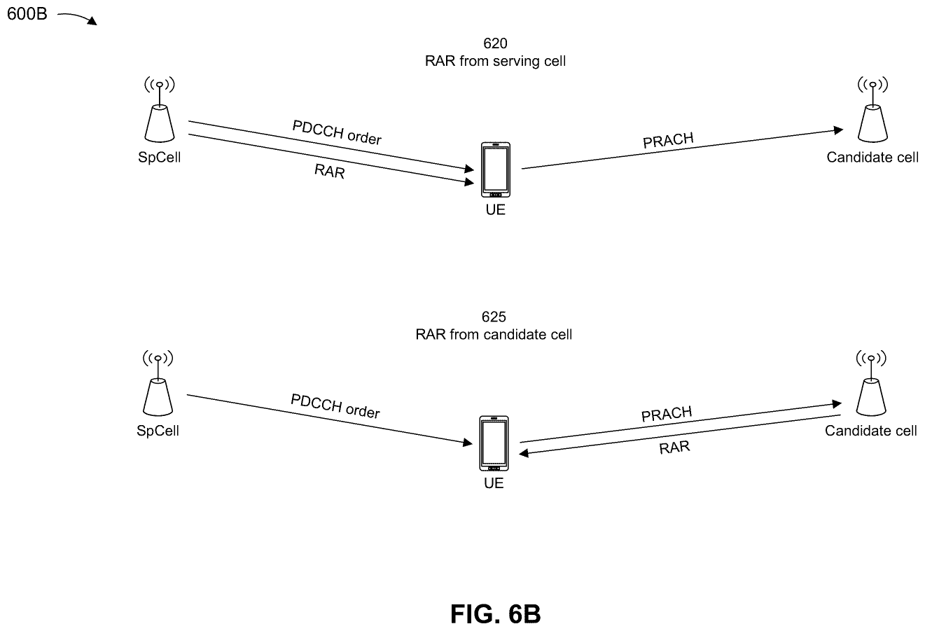

FIGS. 6A-6B are diagram illustrating examples 600A and 600B of a PDCCH-ordered RACH for a candidate cell, in accordance with the present disclosure.

In some cases, for a PDCCH-ordered RACH in a candidate cell, RAR reception may be configured or indicated for the candidate cell. In some other cases, RAR reception may not be configured for the candidate cell or indicated to the candidate cell. In this case, a timing advance (TA) value to be used for communications with the candidate cell may be indicated in a cell switch command. In some cases, the UE 120 may retransmit a PRACH when reception of the RAR is not configured or indicated. Furthermore, when reception of the RAR is not configured or indicated the UE 120 may determine a transmit power for a subsequent PRACH that is triggered by a PDCCH order. Accordingly, as described herein, examples 600A relate to techniques for retransmitting a PRACH in a candidate cell when a PDCCH order from a serving cell triggers a RACH procedure in a candidate cell and RAR reception is not configured and/or indicated for a candidate cell.

In some cases, as shown by example 610, the UE 120 may not be permitted to autonomously retransmit the PRACH when an initial PRACH transmission fails. For example, in some cases, autonomous PRACH retransmission may be disabled by setting the number of allowed PRACH transmissions may be set to a minimum value of PreambleTransMax=1. In this example, a network node within a cell may transmit a first PDCCH order DCI. The UE 120 may transmit a Msg1 that includes a PRACH. However, the transmission of the Msg1 that includes the PRACH may not be successful (e.g., may not be received by the network node). Subsequently, the network node may transmit a second PDCCH order DCI, and the UE 120 may transmit another Msg1 that includes a PRACH based at least in part on receiving the second PDCCH order DCI.

Alternatively, as shown by example 615, the UE 120 may be permitted to autonomously retransmit a PRACH. In such cases, the number of PRACH retransmissions that are allowed may be defined, for example, based at least in part on the value of a PreambleTransMax parameter. In this example, the network node may transmit a first PDCCH order DCI. The UE 120 may transmit a Msg1 that includes a PRACH. However, the transmission of the Msg1 that includes the PRACH may not be successful. The UE 120 may transmit another Msg1 that includes the PRACH without waiting to receive a second PDCCH order DCI. The number of Msg1 messages that may be transmitted by the UE 120 without receiving the second PDCCH order DCI may be defined by the value of Preamble TransMax.

In some cases, the UE 120 may receive a PDCCH order from a serving cell, and may transmit a PRACH to a candidate cell. The PDCCH order may trigger a RACH procedure, such as for contention-free random access. The PRACH may carry a random access preamble to assist with uplink timing. In some cases, the UE 120 may receive a Msg2 from the special cell. In some other cases, the UE 120 may receive the Msg2 from the candidate cell. The UE 120 may determine a latency value associated with PDCCH order triggering. For example, the UE 120 may calculate the latency as follows:

$$N \_ ( T , 2 ) + Δ\_BWPSwitching + T\_switch ,$$

where N_(T,2) is a fixed time delay, Δ_BWPSwitching is a time delay associated with bandwidth part switching, and T_switch is a time delay associated with switching between a first cell and a second cell. However, the latency value may not include any additional delays resulting from a timing difference between the serving cell and the candidate cell. This may result in the UE 120 receiving the PDCCH order at a time that is later than a time indicated by the latency value.

In some aspects, as shown by examples 600B, RAR reception may be configured and/or indicated for a candidate cell when a PDCCH order from a serving cell triggers a RACH procedure in the candidate cell. For example, as shown by example 620, RAR reception may be configured from a serving cell (e.g., where a special cell (SpCell), such as a primary cell (PCell) or a primary secondary cell (PSCell) transmits a PDCCH order to a UE, the UE then transmits a PRACH to a candidate cell, and the UE then receives a RAR from the serving cell). Alternatively, as shown by example 625, RAR reception may be configured from the candidate cell (e.g., where the SpCell transmits a PDCCH order to a UE, the UE then transmits the PRACH to a candidate cell, and the UE then receives the RAR from the candidate cell). In some aspects, in cases where RAR reception is from the candidate cell, a PDCCH common search space (CSS) of the candidate cell may be configured to the UE.

As indicated above, FIGS. 6A-6B are provided as examples. Other examples may differ from what is described with respect to FIGS. 6A-6B.

FIG. 7 is a diagram illustrating an example 700 of a PDCCH order-triggered RACH procedure in a candidate cell, in accordance with the present disclosure.

As shown by reference number 705, a UE 120 may receive, from a serving cell 110-1, a PDCCH order initiating a RACH procedure in a candidate cell 110-2 (e.g., an LTM candidate cell). As further shown by reference number 710, the UE 120 may determining a timing delay associated with a timing difference between the serving cell 110-1 and the candidate cell 110-2. In some aspects, the UE 120 may receive the indication of the timing difference from the serving cell 110-1 or the timing difference may be defined in a wireless communication standard. In some aspects, the timing delay may correspond to a time difference (e.g., a time delta) between the serving cell 110-1 and the candidate cell 110-2. For example, the timing delay may be associated with a downlink transmission or downlink reception timing difference between the serving cell 110-1 issuing the PDCCH order and the candidate cell 110-2 to which the PRACH is transmitted. In some aspects, the UE 120 may calculate a latency associated with PDCCH order triggering in accordance with the following:

$$N \_ ( T , 2 ) + Δ\_BWPSwitching + Δ\_delay + T\_switch ,$$

where N_(T,2) is a fixed time delay, Δ_BWPSwitching is a time delay associated with bandwidth part switching, Δ_delay is the timing difference between the serving cell 110-1 and the candidate cell 110-2, and T_switch is a time delay associated with switching between a first cell and a second cell. In some aspects, the Δ_delay parameter may be set to the timing difference between the serving cell 110-1 and the candidate cell 110-2 (e.g., as indicated by a T_{SSB} parameter) in cases where the PDCCH order triggering the RACH procedure indicates the candidate cell 110-2 in a cell indicator field. Otherwise, the Δ_delay parameter may be set to zero in cases where a PDCCH order triggering the RACH procedure indicates the serving cell 110-1 in the cell indicator field and/or in cases where the cell indicator field is not present.

As shown by reference number 715, the UE 120 may communicate with the candidate cell 110-2 in accordance with the timing delay. For example, the PDCCH order may be triggered in accordance with the timing delay. For example, in some aspects, the UE 120 may transmit a PRACH communication to the candidate cell 110-2 in accordance with the PDCCH order and the timing delay. For example, in some aspects, the UE 120 may transmit the PRACH in a selected PRACH occasion for which a time between a last symbol of the PDCCH order reception and a first symbol of the PRACH transmission is larger than or equal to the latency that is based at least in part on the N_(T,2) parameter, the Δ_BWPSwitching parameter, the Δ_delay parameter, and the T_switch parameter. Additionally, or alternatively, the UE 120 may receive a Msg2 from a special cell (e.g., the serving cell 110-1) in accordance with the timing delay. In some other aspects, the UE 120 may receive a Msg2 from the candidate cell 110-2 in accordance with the timing delay.

As indicated above, FIG. 7 is provided as an example. Other examples may differ from what is described with regard to FIG. 7.

A downlink beam, such as a network node transmit beam or a UE receive beam, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each network node transmit beam may be associated with an SSB, and a UE may indicate a preferred network node transmit beam by transmitting uplink transmissions in resources of the SSB that are associated with the preferred network node transmit beam. A particular SSB may have an associated TCI state (for example, for an antenna port for beamforming). The network node may, in some examples, indicate a downlink network node transmit beam based at least in part on antenna port QCL properties that are indicated by the TCI state. In some cases, the network node may maintain a set of activated TCI states for downlink shared channel transmissions and a set of activated TCI states for downlink control channel transmissions. The set of activated TCI states for downlink shared channel transmissions may correspond to beams that the network node uses for downlink transmission on a PDSCH. The set of activated TCI states for downlink control channel communications may correspond to beams that the network node may use for downlink transmission on a PDCCH or in a control resource set (CORESET). Additionally, or alternatively, the UE may maintain a set of activated TCI states for receiving the downlink shared channel transmissions and the CORESET transmissions. If a TCI state is activated for the UE, then the UE may have one or more antenna configurations based at least in part on the TCI state, and the UE may not need to reconfigure antennas or antenna weighting configurations. In some examples, the set of activated TCI states (for example, activated PDSCH TCI states and activated CORESET TCI states) for the UE may be configured by a configuration message, such as an RRC message.

In a unified TCI framework, the network node may support common TCI state identification (ID) update and activation to provide common QCL information or common uplink transmission spatial filter or filters across a set of configured component carriers. This type of beam indication may apply to intra-band carrier aggregation (CA), as well as to joint downlink and uplink (DL/UL) and separate downlink and uplink beam indications. The common TCI state ID may imply that one reference signal (RS) determined in accordance with the TCI state(s) indicated by a common TCI state ID is used to provide QCL Type-D indication and to determine uplink transmission spatial filters across the set of configured component carriers. In a unified TCI framework, a TCI state may be provided for downlink (DL) beams and uplink (UL) beams. In some examples, a joint uplink and downlink TCI state may be defined that indicates a common beam for both uplink communications and downlink communications. In some examples, separate TCI states may be defined for uplink communications and downlink communications, such as one or more uplink TCI states and one or more downlink TCI states.

Some networks may use different beam indication types for indicating one or more beams to use for communication via a set of channels. A beam indication may be, or include, a TCI state information element, a beam ID, spatial relation information, a TCI state ID, a closed loop index, a panel ID, a TRP ID, and/or a sounding reference signal (SRS) set ID, among other examples. In some examples, types of beam indication types may include a beam indication that indicates to use a common beam for multiple channels or resources for reference signals, or beam indication types that include a single beam indication that indicates to use a beam for a single channel or a resource for reference signals. As used herein, a unified TCI state indication may refer to a TCI state indication using the unified TCI framework. For example, a unified TCI state indication may include an indication of a TCI state that may be applied to multiple channels and/or reference signals. A TCI state may be used for a downlink beam indication, and a spatial relation may be used for an uplink beam indication. Such beam indications may be referred to herein as “non-unified beam indications.” Non-unified beam indications may be applied to one channel for one communication scheduled in that channel.

In some examples, the network node and the UE may use a unified TCI framework for both downlink and uplink beam indications. In the unified TCI framework, TCI state indications may be used to indicate a joint downlink and uplink TCI state or to indicate separate downlink and uplink TCI states. Such a TCI state indication that may be used to indicate a joint downlink and uplink beam, a separate downlink beam, or a separate uplink beam is referred to herein as a “unified TCI indication” or a “unified TCI state indication.” A unified TCI indication (for example, a joint downlink and uplink TCI state indication and/or separate downlink and uplink TCI state indications) may be applied to multiple channels. For example, the unified TCI indication of a joint uplink and downlink TCI state may be used to indicate a beam direction for one or more downlink channels (for example, PDSCH and/or PDCCH) or reference signals (for example, channel state information reference signals (CSI-RS)) and for one or more uplink channels (for example, PUSCH and/or physical uplink control channel (PUCCH)) or reference signals (for example, an SRS). The unified TCI indication of a separate downlink TCI state may be used to indicate a beam direction for multiple downlink channels (for example, PDSCH and PDCCH) or reference signals (for example, CSI-RS). The unified TCI indication of a separate uplink TCI state may be used to indicate a beam direction to be used for multiple uplink channels (for example, PUSCH and PUCCH) or reference signals (for example, SRS). In some examples, the unified TCI indication may be “sticky,” such that the indicated beam direction will be used for the channels and/or reference signals to which the TCI state indication applies until a further indication is received.

In some examples, there may be two TCI state indication modes in the unified TCI framework. A first mode may be a separate downlink and uplink TCI state indication mode, in which separate downlink and uplink TCI states are used to indicate downlink and uplink beam directions for the UE. For example, the separate downlink and uplink TCI state indication mode may be used when the UE is having maximum permissible exposure (MPE) issues to indicate different beam directions, for the UE, for an uplink beam (for example, a UE Tx beam) and a downlink beam (for example, a UE Rx beam). A second mode may be a joint downlink and uplink TCI state indication mode, in which a TCI state indication is used to indicate, to the UE, a joint uplink and downlink beam direction. For example, the joint downlink and uplink TCI state indication mode may be used when the UE has channel correspondence between downlink and uplink channels (which may be assumed in some examples), and the same beam direction can be used for an uplink beam (for example, a UE Tx beam) and a downlink beam (for example, a UE Rx beam).

A CSC may indicate for a UE to switch from a first cell to a second cell (e.g., to switch from communicating with a current cell to communicating with a target cell). In some cases, the cell switch command may indicate a unified TCI for the target cell. However, some channels or reference signals used for communicating with the target cell may not be configured to follow the unified TCI. This may result in the UE not being able to determine TCI or beam information for communicating with the target cell.

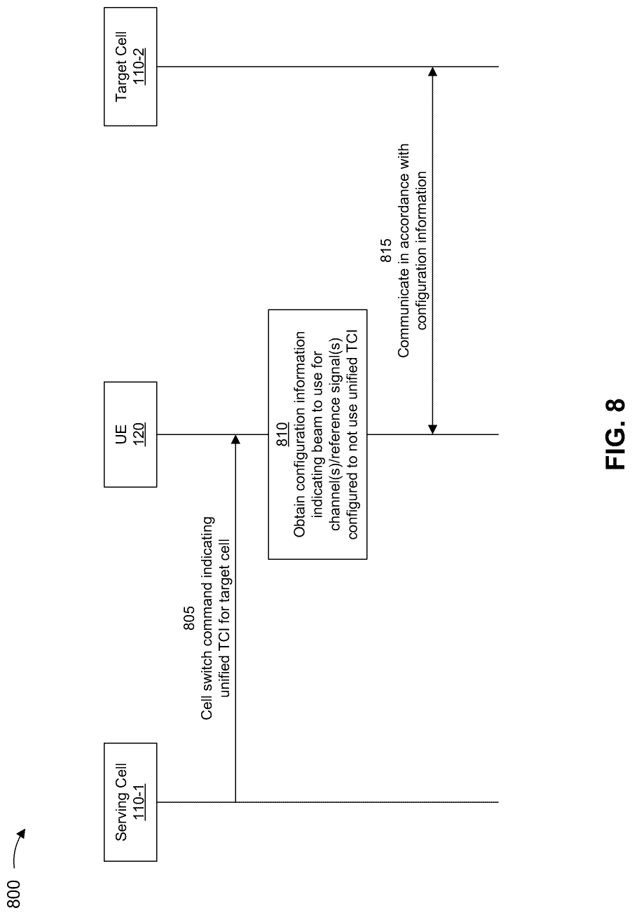

FIG. 8 is a diagram illustrating an example 800 of a unified TCI indication, in accordance with the present disclosure.

As shown by reference number 805, a serving cell 110-1 may transmit, and a UE 120 may receive, a cell switch command, associated with a switch from the serving cell 110-1 to a target cell 110-2. In some aspects, the cell switch command may include a unified TCI for the target cell 110-2.

As shown by reference number 810, the UE 120 may obtain configuration information indicating that at least one channel or reference signal for the target cell 110-2 is to use a TCI that is not associated with a unified TCI. For example, the UE 120 may obtain an indication that the at least one channel or reference signal for the target cell 110-2 is configured not to use the unified TCI (e.g., in CORESET 0).

As shown by reference number 815, the UE 120 and the target cell 110-2 may communicate in accordance with the cell switch command.

In some aspects, all applicable channels and reference signals associated with the target cell may need to be configured to follow the unified TCI. In this case, a single unified TCI or beam indication may be included in the cell switch command for the target cell. In some other aspects, only some of the applicable channels and reference signals associated with the target cell may need to be configured to follow the unified TCI. In one example, separate non-unified TCI may be indicated for each channel or reference signal. The non-unified TCI may be indicated before the cell switch command, with the cell switch command, or after the cell switch command. In another example, the applicable channels and reference signals may follow a default TCI, such as a TCI that is based at least in part on an SSB in a most recent PRACH (e.g., for TA acquisition), or may follow the beam indication in the cell switch command.

As indicated above, FIG. 8 is provided as an example. Other examples may differ from what is described with regard to FIG. 8.

In some cases, activating TCI for a candidate cell may require a transmission of one or more communications to a UE. For example, a serving cell and/or a candidate cell may transmit separate communications to the UE to indicate the TCI for the candidate cell and/or to activate the TCI for the candidate cell. This may result in increased system overhead.

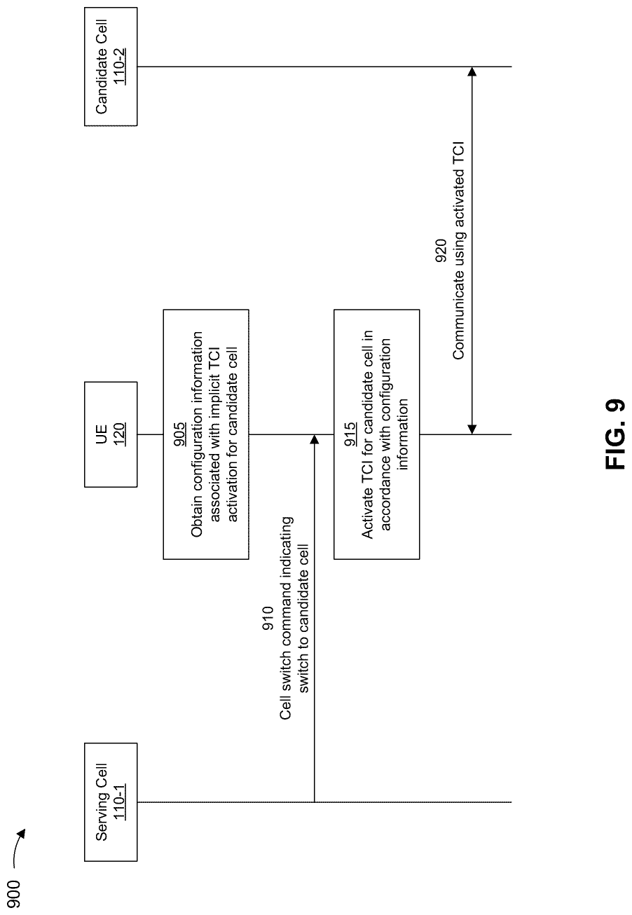

FIG. 9 is a diagram illustrating an example 900 of implicit TCI activation, in accordance with the present disclosure.

As shown by reference number 905, the UE 120 may obtain configuration information that indicates for the UE 120 to perform implicit TCI activation for a candidate cell 110-2 based at least in part on switching from a serving cell 110-1 to the candidate cell 110-2.

As shown by reference number 910, the serving cell 110-1 may transmit, and the UE 120 may receive, a cell switch command that indicates for the UE to switch from the serving cell 110-1 to the candidate cell 110-2.

As shown by reference number 915, the UE 120 may activate the TCI in accordance with the configuration information and the cell switch command. In some aspects, the UE 120 may implicitly activate the TCI, for example, to reduce signaling overhead. In one example, the UE 120 may activate a TCI associated with an SSB that is indicated by a PDCCH order (e.g., for early TA measurement). The timeline for the TCI activation may follow a same timeline as a MAC-CE-based TCI activation (e.g., measuring the SSB at least once after the PDCCH order). In another example, the UE 120 may activate a TCI associated with an SSB indicated in the cell switch command. In another example, an SSB in a candidate cell beam report (e.g., a strongest SSB) may be activated. For example, X top SSBs across a top Y reported cells may be activated. In some aspects, the SSB may need to have a unique CSI-RS in the corresponding TCI. Otherwise, which TCI to activate may be up to the UE 120 or may be based at least in part on a rule (e.g., the SSB with the lowest TCI ID or CSI-RS ID). As further shown by reference number 920, the UE 120 may then communicate with the candidate cell 110-2 using the implicitly activated TCI.

As indicated above, FIG. 9 is provided as an example. Other examples may differ from what is described with regard to FIG. 9.

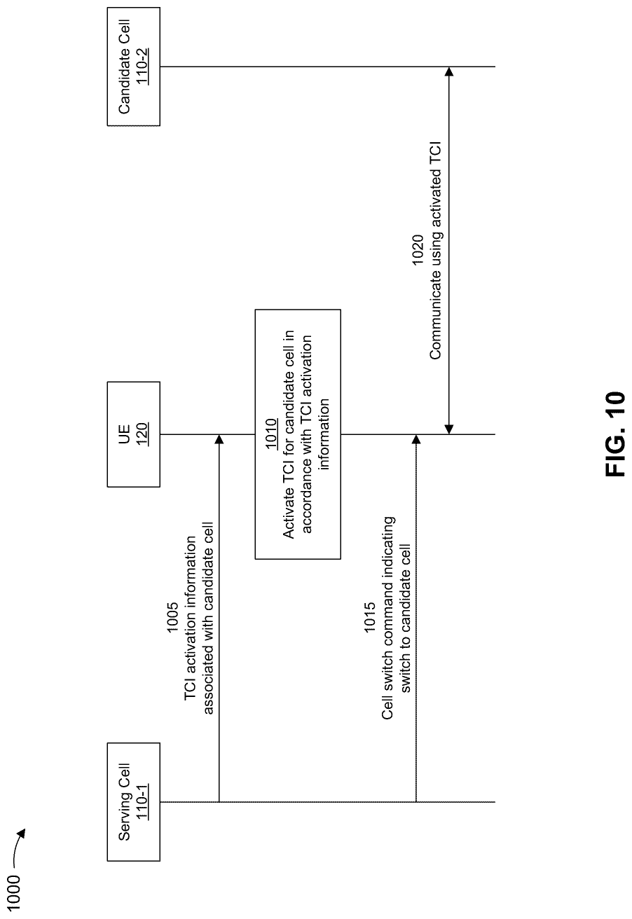

FIG. 10 is a diagram illustrating an example 1000 of UE capability for TCI activation, in accordance with the present disclosure.

As shown by reference number 1005, a serving cell 110-1 may transmit, and the UE 120 may receive, TCI activation information associated with a candidate cell 110-2. The UE 120 may receive the TCI activation information prior to switching from the serving cell 110-1 to the candidate cell 110-2 and/or prior to receiving a cell switch command indicating that the UE 120 is to switch from the serving cell 110-1 to the candidate cell 110-2.

As shown by reference number 1010, the UE 120 may activate a TCI for the candidate cell in accordance with the TCI activation information. As shown by reference number 1015, the network node 110 may transmit, and the UE 120 may receive, after activating the TCI for the candidate cell, a cell switch command that indicates for the UE 120 to switch from a serving cell to the candidate cell. As further shown by reference number 1020, the UE 120 may then communicate with the candidate cell 110-2 using the TCI that was activated prior to the cell switch command.

In some aspects, the TCI activation information may indicate for the UE 120 to activate the TCI for the candidate cell 110-2 based at least in part on the candidate cell 110-2 being an SpCell (e.g., based on a capability of the UE 120 and/or a baseline configuration of a wireless network). In this case, TCIs for other candidate cells that are secondary cells (SCells) may be activated only after the cell switch command. In some other aspects, the TCI activation information may indicate for the UE 120 to activate the TCI for the candidate cell based at least in part on the candidate cell being an SpCell or an SCell (e.g., based on an advanced capability of the UE 120 and/or a configuration of a wireless network). In this case, the cell switch command can also implicitly activate a TCI for one or more new SCells. In some aspects, the TCI activation information may indicate for the UE 120 to activate the TCI for intra-frequency candidate cells that are to be new SCells. Additionally, or alternatively, the TCI activation information may indicate for the UE 120 to activate the TCI for candidate cells with the same bandwidth part (BWP), center frequency, or active BWP and sub-carrier spacing (SCS) (in uplink or downlink) as the serving cell. In some aspects, the TCI activation information may indicate for the UE 120 to activate the TCI for intra-frequency candidate cells and inter-frequency cells that are to be new SCells. Additionally, or alternatively, the TCI activation information may indicate for the UE 120 to activate the TCI for candidate cells with different BWPs, center frequencies, or active BWPs and sub-carrier spacings (in uplink or downlink) as the serving cell. In this case, a QCL source reference signal of the TCI in the inter-frequency cell may be measured after a measurement gap.

As indicated above, FIG. 10 is provided as an example. Other examples may differ from what is described with regard to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with a candidate cell configuration for LTM.

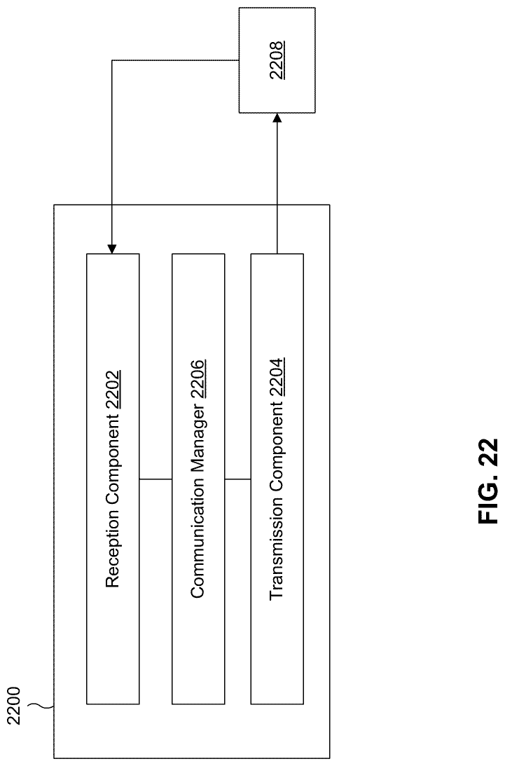

As shown in FIG. 11, in some aspects, process 1100 may include receiving, from a serving cell, a PDCCH order initiating a random access procedure in a candidate cell (block 1110). For example, the UE (e.g., using reception component 2202 and/or communication manager 2206, depicted in FIG. 22) may receive, from a serving cell, a PDCCH order initiating a random access procedure in a candidate cell, as described above.

As further shown in FIG. 11, in some aspects, process 1100 may include determining a timing delay associated with a timing difference between the serving cell and the candidate cell (block 1120). For example, the UE (e.g., using communication manager 2206, depicted in FIG. 22) may determine a timing delay associated with a timing difference between the serving cell and the candidate cell, as described above.

As further shown in FIG. 11, in some aspects, process 1100 may include transmitting a PRACH communication to the candidate cell in accordance with the PDCCH order and the timing delay (block 1130). For example, the UE (e.g., using transmission component 2204 and/or communication manager 2206, depicted in FIG. 22) may transmit a PRACH communication to the candidate cell in accordance with the PDCCH order and the timing delay, as described above.

Process 1100 may include additional aspects, such as any single aspect or any combination of aspects described below and/or in connection with one or more other processes described elsewhere herein.

In a first aspect, the timing difference is associated with downlink transmission timing difference or a downlink reception timing difference between the serving cell and the candidate cell.

In a second aspect, alone or in combination with the first aspect, the PRACH communication is transmitted to the candidate cell in accordance with a latency that is based at least in part on a fixed time delay, a bandwidth part switching delta, the timing delay, and a switching time.

In a third aspect, alone or in combination with one or more of the first and second aspects, the PRACH communication is transmitted in a PRACH occasion for which a time between a last symbol of the PDCCH order and a first symbol of the PRACH communication is larger than or equal to a latency that is based at least in part on the timing difference between the serving cell and the candidate cell.

In a fourth aspect, alone or in combination with one or more of the first through third aspects, process 1100 includes receiving a RAR message from the serving cell in accordance with the timing delay.

In a fifth aspect, alone or in combination with one or more of the first through fourth aspects, process 1100 includes receiving a RAR message from the candidate cell in accordance with the timing delay.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with a candidate cell configuration for LTM.

As shown in FIG. 12, in some aspects, process 1200 may include receiving a cell switch command, associated with a switch from a serving cell to a target cell, that indicates a unified TCI for the target cell (block 1210). For example, the UE (e.g., using reception component 2202 and/or communication manager 2206, depicted in FIG. 22) may receive a cell switch command, associated with a switch from a serving cell to a target cell, that indicates a unified TCI for the target cell, as described above.

As further shown in FIG. 12, in some aspects, process 1200 may include obtaining configuration information that indicates a beam to use for receiving or transmitting at least one channel or reference signal configured to not use the unified TCI (block 1220). For example, the UE (e.g., using reception component 2202 and/or communication manager 2206, depicted in FIG. 22) may obtain configuration information that indicates a beam to use for receiving or transmitting at least one channel or reference signal configured to not use the unified TCI, as described above.

As further shown in FIG. 12, in some aspects, process 1200 may include communicating in the target cell in accordance with the configuration information (block 1230). For example, the UE (e.g., using reception component 2202, transmission component 2204, and/or communication manager 2206, depicted in FIG. 22) may communicate in the target cell in accordance with the configuration information, as described above.

Process 1200 may include additional aspects, such as any single aspect or any combination of aspects described below and/or in connection with one or more other processes described elsewhere herein.

In a first aspect, the configuration information indicates that all channels and reference signals in the target cell are to use the unified TCI indicated in the cell switch command.

In a second aspect, alone or in combination with the first aspect, the configuration information indicates that a first channel or reference signal is to use the unified TCI indicated in the cell switch command and that a second channel or reference signal is to not use the unified TCI indicated in the cell switch command.

In a third aspect, alone or in combination with one or more of the first and second aspects, obtaining the configuration information includes receiving a non-unified TCI that indicates the beam to use for receiving or transmitting the at least one channel or reference signal configured to not use the unified TCI.

In a fourth aspect, alone or in combination with one or more of the first through third aspects, the non-unified TCI is received prior to the cell switch command, included in the cell switch command, or after the cell switch command.

In a fifth aspect, alone or in combination with one or more of the first through fourth aspects, the configuration information indicates that a default TCI or a beam indication indicated in the cell switch command is to be used for receiving or transmitting the at least one channel or reference signal configured to not use the unified TCI.

In a sixth aspect, alone or in combination with one or more of the first through fifth aspects, the default TCI corresponds to an SSB included in a PRACH.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with candidate cell configuration for LTM.

As shown in FIG. 13, in some aspects, process 1300 may include obtaining configuration information associated with implicit TCI activation based at least in part on switching from a first cell to a second cell (block 1310). For example, the UE (e.g., using reception component 2202 and/or communication manager 2206, depicted in FIG. 22) may obtain configuration information associated with implicit TCI activation based at least in part on switching from a first cell to a second cell, as described above.

As further shown in FIG. 13, in some aspects, process 1300 may include receiving a cell switch command that includes an indication to switch from the first cell to the second cell (block 1320). For example, the UE (e.g., using reception component 2202 and/or communication manager 2206, depicted in FIG. 22) may receive a cell switch command that includes an indication to switch from the first cell to the second cell, as described above.

As further shown in FIG. 13, in some aspects, process 1300 may include activating a TCI for the second cell in accordance with the configuration information and the cell switch command (block 1330). For example, the UE (e.g., using communication manager 2206, depicted in FIG. 22) may activate a TCI for the second cell in accordance with the configuration information and the cell switch command, as described above.

Process 1300 may include additional aspects, such as any single aspect or any combination of aspects described below and/or in connection with one or more other processes described elsewhere herein.

In a first aspect, the configuration information indicates that the TCI that is activated in accordance with the cell switch command is associated with an SSB indicated in a PDCCH order for measuring a timing advance associated with the second cell.

In a second aspect, alone or in combination with the first aspect, the configuration information indicates that the TCI that is activated in accordance with the cell switch command is associated with an SSB indicated in the cell switch command.

In a third aspect, alone or in combination with one or more of the first and second aspects, the configuration information indicates that the TCI that is activated in accordance with the cell switch command is an SSB included in a beam report associated with the second cell.

In a fourth aspect, alone or in combination with one or more of the first through third aspects, the TCI is activated for the second cell before receiving the cell switch command that includes the indication to switch from the first cell to the second cell based at least in part on a capability of the UE.

In a fifth aspect, alone or in combination with one or more of the first through fourth aspects, the TCI is activated for the second cell before receiving the cell switch command that includes the indication to switch from the first cell to the second cell based at least in part on the second cell being a special cell.

In a sixth aspect, alone or in combination with one or more of the first through fifth aspects, the TCI is activated for the second cell before receiving the cell switch command that includes the indication to switch from the first cell to the second cell based at least in part on the second cell being a secondary cell.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with physical downlink control channel order reception.

As shown in FIG. 14, in some aspects, process 1400 may include obtaining an indication of a timing delay associated with PDCCH order reception from a serving cell and PRACH transmission to a candidate cell (block 1410). For example, the UE (e.g., using reception component 2202 and/or communication manager 2206, depicted in FIG. 22) may obtain an indication of a timing delay associated with PDCCH order reception from a serving cell and PRACH transmission to a candidate cell, as described above.

As further shown in FIG. 14, in some aspects, process 1400 may include communicating in accordance with the timing delay (block 1420). For example, the UE (e.g., using reception component 2202, transmission component 2204, and/or communication manager 2206, depicted in FIG. 22) may communicate in accordance with the timing delay, as described above.

Process 1400 may include additional aspects, such as any single aspect or any combination of aspects described below and/or in connection with one or more other processes described elsewhere herein.

In a first aspect, the timing delay is associated with a time delta between the serving cell and the candidate cell.

In a second aspect, alone or in combination with the first aspect, communicating in accordance with the timing delay comprises communicating in accordance with a fixed time delay, a bandwidth part switching delta, the timing delay, and a switching time.

In a third aspect, alone or in combination with one or more of the first and second aspects, process 1400 includes receiving a Message 2 from the serving cell in accordance with the timing delay.

In a fourth aspect, alone or in combination with one or more of the first through third aspects, process 1400 includes receiving a Message 2 from the candidate cell in accordance with the timing delay.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 110) performs operations associated with physical downlink control channel order reception.

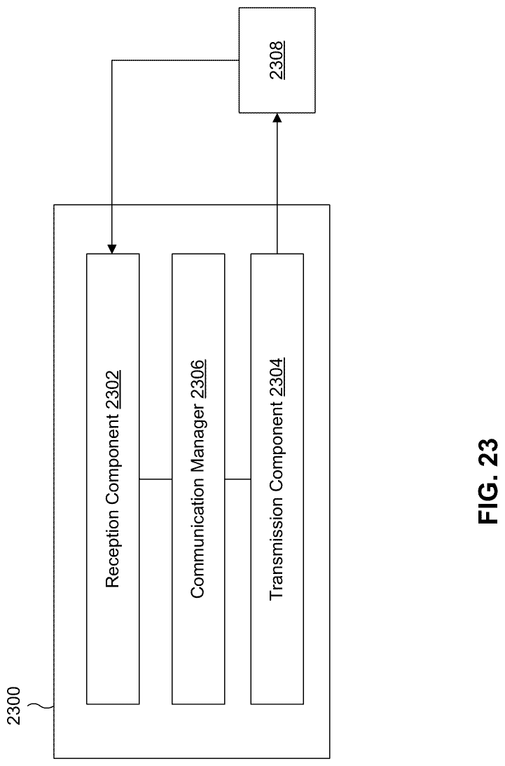

As shown in FIG. 15, in some aspects, process 1500 may include obtaining an indication of a timing delay associated with PDCCH order reception from a serving cell and PRACH transmission to a candidate cell (block 1510). For example, the network node (e.g., using reception component 2302 and/or communication manager 2306, depicted in FIG. 23) may obtain an indication of a timing delay associated with PDCCH order reception from a serving cell and PRACH transmission to a candidate cell, as described above.

As further shown in FIG. 15, in some aspects, process 1500 may include communicating in accordance with the timing delay (block 1520). For example, the network node (e.g., using reception component 2302, transmission component 2304, and/or communication manager 2306, depicted in FIG. 23) may communicate in accordance with the timing delay, as described above.

Process 1500 may include additional aspects, such as any single aspect or any combination of aspects described below and/or in connection with one or more other processes described elsewhere herein.

In a first aspect, the timing delay is associated with a time delta between receiving the PDCCH order from the serving cell and transmitting the PRACH transmission to the candidate cell.

In a second aspect, alone or in combination with the first aspect, communicating in accordance with the timing delay comprises communicating in accordance with a fixed time delay, a bandwidth part switching delta, the timing delay, and a switching time.

In a third aspect, alone or in combination with one or more of the first and second aspects, the network node is associated with the serving cell.

In a fourth aspect, alone or in combination with one or more of the first through third aspects, the network node is associated with the candidate cell.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a UE, in accordance with the present disclosure. Example process 1600 is an example where the UE (e.g., UE 120) performs operations associated with unified TCI indication.

As shown in FIG. 16, in some aspects, process 1600 may include obtaining an indication that at least one channel or reference signal for a target cell is to use a TCI that is not associated with a unified TCI (block 1610). For example, the UE (e.g., using reception component 2202 and/or communication manager 2206, depicted in FIG. 22) may obtain an indication that at least one channel or reference signal for a target cell is to use a TCI that is not associated with a unified TCI, as described above.

As further shown in FIG. 16, in some aspects, process 1600 may include receiving a cell switch command, associated with a switch from a serving cell to the target cell, that indicates the unified TCI for the target cell (block 1620). For example, the UE (e.g., using reception component 2202 and/or communication manager 2206, depicted in FIG. 22) may receive a cell switch command, associated with a switch from a serving cell to the target cell, that indicates the unified TCI for the target cell, as described above.

As further shown in FIG. 16, in some aspects, process 1600 may include communicating in accordance with the cell switch command (block 1630). For example, the UE (e.g., using reception component 2202, transmission component 2204, and/or communication manager 2206, depicted in FIG. 22) may communicate in accordance with the cell switch command, as described above.

Process 1600 may include additional aspects, such as any single aspect or any combination of aspects described below and/or in connection with one or more other processes described elsewhere herein.

In a first aspect, process 1600 includes receiving an indication that all channels and reference signals used for communicating with the target cell are to use the unified TCI.

In a second aspect, alone or in combination with the first aspect, the cell switch command includes a single unified TCI indication or a single beam indication for the target cell.

In a third aspect, alone or in combination with one or more of the first and second aspects, process 1600 includes receiving an indication that a first channel or reference signal is to use the unified TCI and a second channel or reference signal is to use the TCI that is not associated with the unified TCI.

In a fourth aspect, alone or in combination with one or more of the first through third aspects, process 1600 includes receiving a non-unified TCI that indicates the TCI that is not associated with the unified TCI.

In a fifth aspect, alone or in combination with one or more of the first through fourth aspects, the non-unified TCI is received prior to the cell switch command.

In a sixth aspect, alone or in combination with one or more of the first through fifth aspects, the non-unified TCI is included in the cell switch command.

In a seventh aspect, alone or in combination with one or more of the first through sixth aspects, the non-unified TCI is received after the cell switch command.

In an eighth aspect, alone or in combination with one or more of the first through seventh aspects, process 1600 includes using a default TCI or a beam indication that is indicated in the cell switch command.

In a ninth aspect, alone or in combination with one or more of the first through eighth aspects, the default TCI corresponds to an SSB included in a PRACH.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a network node, in accordance with the present disclosure. Example process 1700 is an example where the network node (e.g., network node 110) performs operations associated with unified TCI indication.

As shown in FIG. 17, in some aspects, process 1700 may include obtaining an indication that at least one channel or reference signal for a target cell is to use a TCI that is not associated with a unified TCI (block 1710). For example, the network node (e.g., using reception component 2302 and/or communication manager 2306, depicted in FIG. 23) may obtain an indication that at least one channel or reference signal for a target cell is to use a TCI that is not associated with a unified TCI, as described above.

As further shown in FIG. 17, in some aspects, process 1700 may include transmitting a cell switch command, associated with a switch from a serving cell to the target cell, that indicates the unified TCI for the target cell (block 1720). For example, the network node (e.g., using transmission component 2304 and/or communication manager 2306, depicted in FIG. 23) may transmit a cell switch command, associated with a switch from a serving cell to the target cell, that indicates the unified TCI for the target cell, as described above.

As further shown in FIG. 17, in some aspects, process 1700 may include communicating in accordance with the cell switch command (block 1730). For example, the network node (e.g., using reception component 2302, transmission component 2304, and/or communication manager 2306, depicted in FIG. 23) may communicate in accordance with the cell switch command, as described above.

Process 1700 may include additional aspects, such as any single aspect or any combination of aspects described below and/or in connection with one or more other processes described elsewhere herein.

In a first aspect, process 1700 includes transmitting an indication that all channels and reference signals used for communicating with the target cell are to use the unified TCI.

In a second aspect, alone or in combination with the first aspect, the cell switch command includes a single unified TCI indication or a single beam indication for the target cell.

In a third aspect, alone or in combination with one or more of the first and second aspects, process 1700 includes transmitting an indication that a first channel or reference signal is to use the unified TCI and a second channel or reference signal is to use the TCI that is not associated with the unified TCI.

In a fourth aspect, alone or in combination with one or more of the first through third aspects, process 1700 includes transmitting a non-unified TCI that indicates the TCI that is not associated with the unified TCI.

In a fifth aspect, alone or in combination with one or more of the first through fourth aspects, the non-unified TCI is transmitted prior to the cell switch command.

In a sixth aspect, alone or in combination with one or more of the first through fifth aspects, the non-unified TCI included in the cell switch command.

In a seventh aspect, alone or in combination with one or more of the first through sixth aspects, the non-unified TCI is transmitted after the cell switch command.

In an eighth aspect, alone or in combination with one or more of the first through seventh aspects, process 1700 includes using a default TCI or a beam indication that is indicated in the cell switch command.

In a ninth aspect, alone or in combination with one or more of the first through eighth aspects, the default TCI corresponds to an SSB included in a PRACH.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a UE, in accordance with the present disclosure. Example process 1800 is an example where the UE (e.g., UE 120) performs operations associated with implicit TCI activation.

As shown in FIG. 18, in some aspects, process 1800 may include obtaining configuration information that indicates for the UE to perform implicit TCI activation based at least in part on switching from a first cell to a second cell (block 1810). For example, the UE (e.g., using reception component 2202 and/or communication manager 2206, depicted in FIG. 22) may obtain configuration information that indicates for the UE to perform implicit TCI activation based at least in part on switching from a first cell to a second cell, as described above.

As further shown in FIG. 18, in some aspects, process 1800 may include receiving a cell switch command that indicates for the UE to switch from the first cell to the second cell (block 1820). For example, the UE (e.g., using reception component 2202 and/or communication manager 2206, depicted in FIG. 22) may receive a cell switch command that indicates for the UE to switch from the first cell to the second cell, as described above.

As further shown in FIG. 18, in some aspects, process 1800 may include activating a TCI in accordance with the configuration information and the cell switch command (block 1830). For example, the UE (e.g., using communication manager 2206, depicted in FIG. 22) may activate a TCI in accordance with the configuration information and the cell switch command, as described above.

Process 1800 may include additional aspects, such as any single aspect or any combination of aspects described below and/or in connection with one or more other processes described elsewhere herein.

In a first aspect, the configuration information that indicates for the UE to perform the implicit TCI activation indicates for the UE to activate the TCI in accordance with an SSB included in a physical downlink control channel order for timing advance measurement.

In a second aspect, alone or in combination with the first aspect, the configuration information that indicates for the UE to perform the implicit TCI activation indicates for the UE to activate the TCI in accordance with an SSB included in the cell switch command.

In a third aspect, alone or in combination with one or more of the first and second aspects, the configuration information that indicates for the UE to perform the implicit TCI activation indicates for the UE to activate the TCI in accordance with an SSB included in a beam report associated with the second cell.

In a fourth aspect, alone or in combination with one or more of the first through third aspects, the SSB included in the beam report associated with the second cell is associated with a strongest measurement of a plurality of measurements associated with a plurality of respective SSBs.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a network node, in accordance with the present disclosure. Example process 1900 is an example where the network node (e.g., network node 110) performs operations associated with implicit TCI activation.

As shown in FIG. 19, in some aspects, process 1900 may include transmitting configuration information that indicates for a UE to perform implicit TCI activation based at least in part on switching from a first cell to a second cell (block 1910). For example, the network node (e.g., using transmission component 2304 and/or communication manager 2306, depicted in FIG. 23) may transmit configuration information that indicates for a UE to perform implicit TCI activation based at least in part on switching from a first cell to a second cell, as described above.

As further shown in FIG. 19, in some aspects, process 1900 may include transmitting a cell switch command that indicates for the UE to switch from the first cell to the second cell (block 1920). For example, the network node (e.g., using transmission component 2304 and/or communication manager 2306, depicted in FIG. 23) may transmit a cell switch command that indicates for the UE to switch from the first cell to the second cell, as described above.

Process 1900 may include additional aspects, such as any single aspect or any combination of aspects described below and/or in connection with one or more other processes described elsewhere herein.

In a first aspect, the configuration information that indicates for the UE to perform the implicit TCI activation indicates for the UE to activate the TCI in accordance with an SSB included in a PDCCH order for timing advance measurement.

In a second aspect, alone or in combination with the first aspect, the configuration information that indicates for the UE to perform the implicit TCI activation indicates for the UE to activate the TCI in accordance with an SSB included in the cell switch command.

In a third aspect, alone or in combination with one or more of the first and second aspects, the configuration information that indicates for the UE to perform the implicit TCI activation indicates for the UE to activate the TCI in accordance with an SSB included in a beam report associated with the second cell.

In a fourth aspect, alone or in combination with one or more of the first through third aspects, the SSB included in the beam report associated with the second cell is associated with a strongest measurement of a plurality of measurements associated with a plurality of respective SSBs.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, by a UE, in accordance with the present disclosure. Example process 2000 is an example where the UE (e.g., UE 120) performs operations associated with UE capability for TCI activation.

As shown in FIG. 20, in some aspects, process 2000 may include receiving TCI activation information associated with a first cell (block 2010). For example, the UE (e.g., using reception component 2202 and/or communication manager 2206, depicted in FIG. 22) may receive TCI activation information associated with a first cell, as described above.

As further shown in FIG. 20, in some aspects, process 2000 may include activating a TCI for the first cell in accordance with the TCI activation information (block 2020). For example, the UE (e.g., using communication manager 2206, depicted in FIG. 22) may activate a TCI for the first cell in accordance with the TCI activation information, as described above.

As further shown in FIG. 20, in some aspects, process 2000 may include receiving, after activating the TCI for the first cell, a cell switch command that indicates for the UE to switch from a second cell to the first cell (block 2030). For example, the UE (e.g., using reception component 2202 and/or communication manager 2206, depicted in FIG. 22) may receive, after activating the TCI for the first cell, a cell switch command that indicates for the UE to switch from a second cell to the first cell, as described above.

Process 2000 may include additional aspects, such as any single aspect or any combination of aspects described below and/or in connection with one or more other processes described elsewhere herein.

In a first aspect, activating the TCI for the first cell comprises activating the TCI for a special cell.

In a second aspect, alone or in combination with the first aspect, process 2000 includes activating, after receiving the cell switch command, a TCI for at least one secondary cell.

In a third aspect, alone or in combination with one or more of the first and second aspects, activating the TCI for the first cell comprises activating the TCI for a special cell and at least one secondary cell.

In a fourth aspect, alone or in combination with one or more of the first through third aspects, activating the TCI for the special cell and the at least one secondary cell comprises activating the TCI for one or more intra-frequency secondary cells.

In a fifth aspect, alone or in combination with one or more of the first through fourth aspects, activating the TCI for the special cell and the at least one secondary cell comprises activating the TCI for one or more intra-frequency secondary cells and one or more inter-frequency secondary cells.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, by a network node, in accordance with the present disclosure. Example process 2100 is an example where the network node (e.g., network node 110) performs operations associated with UE capability for TCI activation.

As shown in FIG. 21, in some aspects, process 2100 may include transmitting configuration information that indicates for a UE to activate a TCI for a first cell prior to receiving a cell switch command that indicates for the UE to switch from a second cell to the first cell (block 2110). For example, the network node (e.g., using transmission component 2304 and/or communication manager 2306, depicted in FIG. 23) may transmit configuration information that indicates for a UE to activate a TCI for a first cell prior to receiving a cell switch command that indicates for the UE to switch from a second cell to the first cell, as described above.

As further shown in FIG. 21, in some aspects, process 2100 may include transmitting the cell switch command that indicates for the UE to switch from the second cell to the first cell (block 2120). For example, the network node (e.g., using transmission component 2304 and/or communication manager 2306, depicted in FIG. 23) may transmit the cell switch command that indicates for the UE to switch from the second cell to the first cell, as described above.

Process 2100 may include additional aspects, such as any single aspect or any combination of aspects described below and/or in connection with one or more other processes described elsewhere herein.

In a first aspect, transmitting the configuration information that indicates for the UE to activate the TCI for the first cell prior to receiving the cell switch command indicates for the UE to activate the TCI for a special cell.

In a second aspect, alone or in combination with the first aspect, transmitting the configuration information that indicates for the UE to activate the TCI for the first cell prior to receiving the cell switch command indicates for the UE to activate the TCI for a special cell and at least one secondary cell.

In a third aspect, alone or in combination with one or more of the first and second aspects, transmitting the configuration information that indicates for the UE to activate the TCI for the special cell and the at least one secondary cell indicates for the UE to activate the TCI for one or more intra-frequency secondary cells.

In a fourth aspect, alone or in combination with one or more of the first through third aspects, transmitting the configuration information that indicates for the UE to activate the TCI for the special cell and the at least one secondary cell indicates for the UE to activate the TCI for one or more intra-frequency secondary cells and one or more inter-frequency secondary cells.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram of an example apparatus 2200 for wireless communication, in accordance with the present disclosure. The apparatus 2200 may be a UE, or a UE may include the apparatus 2200. In some aspects, the apparatus 2200 includes a reception component 2202, a transmission component 2204, and/or a communication manager 2206, which may be in communication with one another (for example, via one or more buses and/or one or more other components). In some aspects, the communication manager 2206 is the communication manager 140 described in connection with FIG. 1. As shown, the apparatus 2200 may communicate with another apparatus 2208, such as a UE or a network node (such as a CU, a DU, an RU, or a base station), using the reception component 2202 and the transmission component 2204.

In some aspects, the apparatus 2200 may be configured to perform one or more operations described herein in connection with FIGS. 7-10. Additionally, or alternatively, the apparatus 2200 may be configured to perform one or more processes described herein, such as process 1100 of FIG. 11, process 1200 of FIG. 12, process 1300 of FIG. 13, process 1400 of FIG. 14, process 1600 of FIG. 16, process 1800 of FIG. 18, process 2000 of FIG. 20, or a combination thereof. In some aspects, the apparatus 2200 and/or one or more components shown in FIG. 22 may include one or more components of the UE described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2202 may receive communications, such as reference signals, control information, data communications, or a combination thereof, from the apparatus 2208. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, a modem, a demodulator, a MIMO detector, a receive processor, a controller/processor, a memory, or a combination thereof, of the UE described in connection with FIG. 2.

The transmission component 2204 may transmit communications, such as reference signals, control information, data communications, or a combination thereof, to the apparatus 2208. In some aspects, one or more other components of the apparatus 2200 may generate communications and may provide the generated communications to the transmission component 2204 for transmission to the apparatus 2208. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2208. In some aspects, the transmission component 2204 may include one or more antennas, a modem, a modulator, a transmit MIMO processor, a transmit processor, a controller/processor, a memory, or a combination thereof, of the UE described in connection with FIG. 2. In some aspects, the transmission component 2204 may be co-located with the reception component 2202 in a transceiver.

The communication manager 2206 may support operations of the reception component 2202 and/or the transmission component 2204. For example, the communication manager 2206 may receive information associated with configuring reception of communications by the reception component 2202 and/or transmission of communications by the transmission component 2204. Additionally, or alternatively, the communication manager 2206 may generate and/or provide control information to the reception component 2202 and/or the transmission component 2204 to control reception and/or transmission of communications.

The reception component 2202 may receive, from a serving cell, a PDCCH order initiating a random access procedure in a candidate cell. The communication manager 2206 may determine a timing delay associated with a timing difference between the serving cell and the candidate cell. The transmission component 2204 may transmit a PRACH communication to the candidate cell in accordance with the PDCCH order and the timing delay.

The reception component 2202 may receive a cell switch command, associated with a switch from a serving cell to a target cell, that indicates a unified TCI for the target cell. The communication manager 2206 may obtain configuration information that indicates a beam to use for receiving or transmitting at least one channel or reference signal configured to not use the unified TCI. The transmission component 2204 may communicate in the target cell in accordance with the configuration information.

The communication manager 2206 may obtain configuration information associated with implicit TCI activation based at least in part on switching from a first cell to a second cell. The reception component 2202 may receive a cell switch command that includes an indication to switch from the first cell to the second cell. The communication manager 2206 may activate a TCI for the second cell in accordance with the configuration information and the cell switch command.

The reception component 2202 may obtain an indication of a timing delay associated with PDCCH order reception from a serving cell and PRACH transmission to a candidate cell. The reception component 2202 and/or the transmission component 2204 may communicate in accordance with the timing delay.

The reception component 2202 may receive a Message 2 from the serving cell in accordance with the timing delay. The reception component 2202 may receive a Message 2 from the candidate cell in accordance with the timing delay.

The reception component 2202 may obtain an indication that at least one channel or reference signal for a target cell is to use a TCI that is not associated with a unified TCI. The reception component 2202 may receive a cell switch command, associated with a switch from a serving cell to the target cell, that indicates the unified TCI for the target cell. The reception component 2202 and/or the transmission component 2204 may communicate in accordance with the cell switch command.

The reception component 2202 may receive an indication that all channels and reference signals used for communicating with the target cell are to use the unified TCI. The reception component 2202 may receive an indication that a first channel or reference signal is to use the unified TCI and a second channel or reference signal is to use the TCI that is not associated with the unified TCI. The reception component 2202 may receive a non-unified TCI that indicates the TCI that is not associated with the unified TCI. The communication manager 2206 may use a default TCI or a beam indication that is indicated in the cell switch command.

The reception component 2202 may obtain configuration information that indicates for the UE to perform implicit TCI activation based at least in part on switching from a first cell to a second cell. The reception component 2202 may receive a cell switch command that indicates for the UE to switch from the first cell to the second cell. The communication manager 2206 may activate a TCI in accordance with the configuration information and the cell switch command.

The reception component 2202 may receive TCI activation information associated with a first cell. The communication manager 2206 may activate a TCI for the first cell in accordance with the TCI activation information. The reception component 2202 may receive, after activating the TCI for the first cell, a cell switch command that indicates for the UE to switch from a second cell to the first cell.

The communication manager 2206 may activate, after receiving the cell switch command, a TCI for at least one secondary cell.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

FIG. 23 is a diagram of an example apparatus 2300 for wireless communication, in accordance with the present disclosure. The apparatus 2300 may be a network node, or a network node may include the apparatus 2300. In some aspects, the apparatus 2300 includes a reception component 2302, a transmission component 2304, and/or a communication manager 2306, which may be in communication with one another (for example, via one or more buses and/or one or more other components). In some aspects, the communication manager 2306 is the communication manager 200 described in connection with FIG. 1. As shown, the apparatus 2300 may communicate with another apparatus 2308, such as a UE or a network node (such as a CU, a DU, an RU, or a base station), using the reception component 2302 and the transmission component 2304.

In some aspects, the apparatus 2300 may be configured to perform one or more operations described herein in connection with FIGS. 7-10. Additionally, or alternatively, the apparatus 2300 may be configured to perform one or more processes described herein, such as process 1500 of FIG. 15, process 1700 of FIG. 17, process 1900 of FIG. 19, process 2100 of FIG. 21, or a combination thereof. In some aspects, the apparatus 2300 and/or one or more components shown in FIG. 23 may include one or more components of the network node described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2308. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the network node described in connection with FIG. 2. In some aspects, the reception component 2302 and/or the transmission component 2304 may include or may be included in a network interface. The network interface may be configured to obtain and/or output signals for the apparatus 2300 via one or more communications links, such as a backhaul link, a midhaul link, and/or a fronthaul link.

The transmission component 2304 may transmit communications, such as reference signals, control information, data communications, or a combination thereof, to the apparatus 2308. In some aspects, one or more other components of the apparatus 2300 may generate communications and may provide the generated communications to the transmission component 2304 for transmission to the apparatus 2308. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2308. In some aspects, the transmission component 2304 may include one or more antennas, a modem, a modulator, a transmit MIMO processor, a transmit processor, a controller/processor, a memory, or a combination thereof, of the network node described in connection with FIG. 2. In some aspects, the transmission component 2304 may be co-located with the reception component 2302 in a transceiver.

The communication manager 2306 may support operations of the reception component 2302 and/or the transmission component 2304. For example, the communication manager 2306 may receive information associated with configuring reception of communications by the reception component 2302 and/or transmission of communications by the transmission component 2304. Additionally, or alternatively, the communication manager 2306 may generate and/or provide control information to the reception component 2302 and/or the transmission component 2304 to control reception and/or transmission of communications.

The reception component 2302 may obtain an indication of a timing delay associated with PDCCH order reception from a serving cell and PRACH transmission to a candidate cell. The reception component 2302 and/or the transmission component 2304 may communicate in accordance with the timing delay.

The reception component 2302 may obtain an indication that at least one channel or reference signal for a target cell is to use a TCI that is not associated with a unified TCI. The transmission component 2304 may transmit a cell switch command, associated with a switch from a serving cell to the target cell, that indicates the unified TCI for the target cell. The reception component 2302 and/or the transmission component 2304 may communicate in accordance with the cell switch command.

The transmission component 2304 may transmit an indication that all channels and reference signals used for communicating with the target cell are to use the unified TCI.

The transmission component 2304 may transmit an indication that a first channel or reference signal is to use the unified TCI and a second channel or reference signal is to use the TCI that is not associated with the unified TCI.

The transmission component 2304 may transmit a non-unified TCI that indicates the TCI that is not associated with the unified TCI.

The communication manager 2306 may use a default TCI or a beam indication that is indicated in the cell switch command.

The transmission component 2304 may transmit configuration information that indicates for a UE to perform implicit TCI activation based at least in part on switching from a first cell to a second cell. The transmission component 2304 may transmit a cell switch command that indicates for the UE to switch from the first cell to the second cell.

The transmission component 2304 may transmit configuration information that indicates for a UE to activate a TCI for a first cell prior to receiving a cell switch command that indicates for the UE to switch from a second cell to the first cell. The transmission component 2304 may transmit the cell switch command that indicates for the UE to switch from the second cell to the first cell.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

The following provides an overview of some Aspects of the present disclosure:

Aspect 1: A method of wireless communication performed by a UE, comprising: receiving, from a serving cell, a PDCCH order initiating a random access procedure in a candidate cell; determining a timing delay associated with a timing difference between the serving cell and the candidate cell; and transmitting a PRACH communication to the candidate cell in accordance with the PDCCH order and the timing delay.

Aspect 2: The method of Aspect 1, wherein the timing difference is associated with downlink transmission timing difference or a downlink reception timing difference between the serving cell and the candidate cell.

Aspect 3: The method of any of Aspects 1-2, wherein the PRACH communication is transmitted to the candidate cell in accordance with a latency that is based at least in part on a fixed time delay, a bandwidth part switching delta, the timing delay, and a switching time.

Aspect 4: The method of any of Aspects 1-3, wherein the PRACH communication is transmitted in a PRACH occasion for which a time between a last symbol of the PDCCH order and a first symbol of the PRACH communication is larger than or equal to a latency that is based at least in part on the timing difference between the serving cell and the candidate cell.

Aspect 5: The method of any of Aspects 1-4, further comprising receiving a random access response message from the serving cell in accordance with the timing delay.

Aspect 6: The method of any of Aspects 1-5, further comprising receiving a random access response message from the candidate cell in accordance with the timing delay.

Aspect 7: A method of wireless communication performed by a UE, comprising: receiving a cell switch command, associated with a switch from a serving cell to a target cell, that indicates a unified TCI for the target cell; obtaining configuration information that indicates a beam to use for receiving or transmitting at least one channel or reference signal configured to not use the unified TCI; and communicating in the target cell in accordance with the configuration information.

Aspect 8: The method of Aspect 7, wherein the configuration information indicates that all channels and reference signals in the target cell are to use the unified TCI indicated in the cell switch command.

Aspect 9: The method of any of Aspects 7-8, wherein the configuration information indicates that a first channel or reference signal is to use the unified TCI indicated in the cell switch command and that a second channel or reference signal is to not use the unified TCI indicated in the cell switch command.

Aspect 10: The method of any of Aspects 7-9, wherein obtaining the configuration information includes receiving a non-unified TCI that indicates the beam to use for receiving or transmitting the at least one channel or reference signal configured to not use the unified TCI.

Aspect 11: The method of Aspect 10, wherein the non-unified TCI is received prior to the cell switch command, included in the cell switch command, or after the cell switch command.

Aspect 12: The method of any of Aspects 7-11, wherein the configuration information indicates that a default TCI or a beam indication indicated in the cell switch command is to be used for receiving or transmitting the at least one channel or reference signal configured to not use the unified TCI.

Aspect 13: The method of Aspect 12, wherein the default TCI corresponds to a synchronization signal block included in a PRACH.

Aspect 14: A method of wireless communication performed by a UE, comprising: obtaining configuration information associated with implicit TCI activation based at least in part on switching from a first cell to a second cell; receiving a cell switch command that includes an indication to switch from the first cell to the second cell; and activating a TCI for the second cell in accordance with the configuration information and the cell switch command.

Aspect 15: The method of Aspect 14, wherein the configuration information indicates that the TCI that is activated in accordance with the cell switch command is associated with a synchronization signal block indicated in a PDCCH order for measuring a timing advance associated with the second cell.

Aspect 16: The method of any of Aspects 14-15, wherein the configuration information indicates that the TCI that is activated in accordance with the cell switch command is associated with a synchronization signal block indicated in the cell switch command.

Aspect 17: The method of any of Aspects 14-16, wherein the configuration information indicates that the TCI that is activated in accordance with the cell switch command is a synchronization signal block included in a beam report associated with the second cell.

Aspect 18: The method of any of Aspects 14-17, wherein the TCI is activated for the second cell before receiving the cell switch command that includes the indication to switch from the first cell to the second cell based at least in part on a capability of the UE.

Aspect 19: The method of Aspect 18, wherein the TCI is activated for the second cell before receiving the cell switch command that includes the indication to switch from the first cell to the second cell based at least in part on the second cell being a special cell.

Aspect 20: The method of Aspect 18, wherein the TCI is activated for the second cell before receiving the cell switch command that includes the indication to switch from the first cell to the second cell based at least in part on the second cell being a secondary cell.

Aspect 21: A method of wireless communication performed by a UE, comprising: obtaining an indication of a timing delay associated with PDCCH order reception from a serving cell and PRACH transmission to a candidate cell; and communicating in accordance with the timing delay.

Aspect 22: The method of Aspect 21, wherein the timing delay is associated with a time delta between the serving cell and the candidate cell.

Aspect 23: The method of Aspect 22, wherein communicating in accordance with the timing delay comprises communicating in accordance with a fixed time delay, a bandwidth part switching delta, the timing delay, and a switching time.

Aspect 24: The method of any of Aspects 21-23, further comprising receiving a Message 2 from the serving cell in accordance with the timing delay.

Aspect 25: The method of any of Aspects 21-24, further comprising receiving a Message 2 from the candidate cell in accordance with the timing delay.

Aspect 26: A method of wireless communication performed by a network node, comprising: obtaining an indication of a timing delay associated with PDCCH order reception from a serving cell and PRACH transmission to a candidate cell; and communicating in accordance with the timing delay.

Aspect 27: The method of Aspect 26, wherein the timing delay is associated with a time delta between receiving the PDCCH order from the serving cell and transmitting the PRACH transmission to the candidate cell.

Aspect 28: The method of Aspect 27, wherein communicating in accordance with the timing delay comprises communicating in accordance with a fixed time delay, a bandwidth part switching delta, the timing delay, and a switching time.

Aspect 29: The method of any of Aspects 26-28, wherein the network node is associated with the serving cell.

Aspect 30: The method of any of Aspects 26-29, wherein the network node is associated with the candidate cell.

Aspect 31: A method of wireless communication performed by a UE, comprising: obtaining an indication that at least one channel or reference signal for a target cell is to use a TCI that is not associated with a unified TCI; receiving a cell switch command, associated with a switch from a serving cell to the target cell, that indicates the unified TCI for the target cell; and communicating in accordance with the cell switch command.

Aspect 32: The method of Aspect 31, further comprising receiving an indication that all channels and reference signals used for communicating with the target cell are to use the unified TCI.

Aspect 33: The method of Aspect 32, wherein the cell switch command includes a single unified TCI indication or a single beam indication for the target cell.

Aspect 34: The method of any of Aspects 31-33, further comprising receiving an indication that a first channel or reference signal is to use the unified TCI and a second channel or reference signal is to use the TCI that is not associated with the unified TCI.

Aspect 35: The method of Aspect 34, further comprising receiving a non-unified TCI that indicates the TCI that is not associated with the unified TCI.

Aspect 36: The method of Aspect 35, wherein the non-unified TCI is received prior to the cell switch command.

Aspect 37: The method of Aspect 35, wherein the non-unified TCI is included in the cell switch command.

Aspect 38: The method of Aspect 35, wherein the non-unified TCI is received after the cell switch command.

Aspect 39: The method of Aspect 34, further comprising using a default TCI or a beam indication that is indicated in the cell switch command.

Aspect 40: The method of Aspect 39, wherein the default TCI corresponds to an SSB included in a PRACH.

Aspect 41: A method of wireless communication performed by a network node, comprising: obtaining an indication that at least one channel or reference signal for a target cell is to use a TCI that is not associated with a unified TCI; transmitting a cell switch command, associated with a switch from a serving cell to the target cell, that indicates the unified TCI for the target cell; and communicating in accordance with the cell switch command.

Aspect 42: The method of Aspect 41, further comprising transmitting an indication that all channels and reference signals used for communicating with the target cell are to use the unified TCI.

Aspect 43: The method of Aspect 42, wherein the cell switch command includes a single unified TCI indication or a single beam indication for the target cell.

Aspect 44: The method of any of Aspects 41-43, further comprising transmitting an indication that a first channel or reference signal is to use the unified TCI and a second channel or reference signal is to use the TCI that is not associated with the unified TCI.

Aspect 45: The method of Aspect 44, further comprising transmitting a non-unified TCI that indicates the TCI that is not associated with the unified TCI.

Aspect 46: The method of Aspect 45, wherein the non-unified TCI is transmitted prior to the cell switch command.

Aspect 47: The method of Aspect 45, wherein the non-unified TCI included in the cell switch command.

Aspect 48: The method of Aspect 45, wherein the non-unified TCI is transmitted after the cell switch command.

Aspect 49: The method of Aspect 44, further comprising using a default TCI or a beam indication that is indicated in the cell switch command.

Aspect 50: The method of Aspect 49, wherein the default TCI corresponds to an SSB included in a PRACH.

Aspect 51: A method of wireless communication performed by a UE, comprising: obtaining configuration information that indicates for the UE to perform implicit TCI activation based at least in part on switching from a first cell to a second cell; receiving a cell switch command that indicates for the UE to switch from the first cell to the second cell; and activating a TCI in accordance with the configuration information and the cell switch command.

Aspect 52: The method of Aspect 51, wherein the configuration information that indicates for the UE to perform the implicit TCI activation indicates for the UE to activate the TCI in accordance with an SSB included in a PDCCH order for timing advance measurement.

Aspect 53: The method of any of Aspects 51-52, wherein the configuration information that indicates for the UE to perform the implicit TCI activation indicates for the UE to activate the TCI in accordance with an SSB included in the cell switch command.

Aspect 54: The method of any of Aspects 51-53, wherein the configuration information that indicates for the UE to perform the implicit TCI activation indicates for the UE to activate the TCI in accordance with an SSB included in a beam report associated with the second cell.

Aspect 55: The method of Aspect 54, wherein the SSB included in the beam report associated with the second cell is associated with a strongest measurement of a plurality of measurements associated with a plurality of respective SSBs.

Aspect 56: A method of wireless communication performed by a network node, comprising: transmitting configuration information that indicates for a UE to perform implicit TCI activation based at least in part on switching from a first cell to a second cell; and transmitting a cell switch command that indicates for the UE to switch from the first cell to the second cell.

Aspect 57: The method of Aspect 56, wherein the configuration information that indicates for the UE to perform the implicit TCI activation indicates for the UE to activate the TCI in accordance with an SSB included in a PDCCH order for timing advance measurement.

Aspect 58: The method of any of Aspects 56-57, wherein the configuration information that indicates for the UE to perform the implicit TCI activation indicates for the UE to activate the TCI in accordance with an SSB included in the cell switch command.

Aspect 59: The method of any of Aspects 56-58, wherein the configuration information that indicates for the UE to perform the implicit TCI activation indicates for the UE to activate the TCI in accordance with an SSB included in a beam report associated with the second cell.

Aspect 60: The method of Aspect 59, wherein the SSB included in the beam report associated with the second cell is associated with a strongest measurement of a plurality of measurements associated with a plurality of respective SSBs.

Aspect 61: A method of wireless communication performed by a UE, comprising: receiving TCI activation information associated with a first cell; activating a TCI for the first cell in accordance with the TCI activation information; and receiving, after activating the TCI for the first cell, a cell switch command that indicates for the UE to switch from a second cell to the first cell.

Aspect 62: The method of Aspect 61, wherein activating the TCI for the first cell comprises activating the TCI for a special cell.

Aspect 63: The method of Aspect 62, further comprising activating, after receiving the cell switch command, a TCI for at least one secondary cell.

Aspect 64: The method of any of Aspects 61-63, wherein activating the TCI for the first cell comprises activating the TCI for a special cell and at least one secondary cell.

Aspect 65: The method of Aspect 64, wherein activating the TCI for the special cell and the at least one secondary cell comprises activating the TCI for one or more intra-frequency secondary cells.

Aspect 66: The method of Aspect 64, wherein activating the TCI for the special cell and the at least one secondary cell comprises activating the TCI for one or more intra-frequency secondary cells and one or more inter-frequency secondary cells.

Aspect 67: A method of wireless communication performed by a network node, comprising: transmitting configuration information that indicates for a UE to activate a TCI for a first cell prior to receiving a cell switch command that indicates for the UE to switch from a second cell to the first cell; and transmitting the cell switch command that indicates for the UE to switch from the second cell to the first cell.

Aspect 68: The method of Aspect 67, wherein transmitting the configuration information that indicates for the UE to activate the TCI for the first cell prior to receiving the cell switch command indicates for the UE to activate the TCI for a special cell.

Aspect 69: The method of any of Aspects 67-68, wherein transmitting the configuration information that indicates for the UE to activate the TCI for the first cell prior to receiving the cell switch command indicates for the UE to activate the TCI for a special cell and at least one secondary cell.

Aspect 70: The method of Aspect 69, wherein transmitting the configuration information that indicates for the UE to activate the TCI for the special cell and the at least one secondary cell indicates for the UE to activate the TCI for one or more intra-frequency secondary cells.

Aspect 71: The method of Aspect 69, wherein transmitting the configuration information that indicates for the UE to activate the TCI for the special cell and the at least one secondary cell indicates for the UE to activate the TCI for one or more intra-frequency secondary cells and one or more inter-frequency secondary cells.

Aspect 72: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-71.

Aspect 73: An apparatus for wireless communication at a device, the apparatus comprising one or more memories and one or more processors coupled to the one or more memories, the one or more processors configured to cause the device to perform the method of one or more of Aspects 1-71.

Aspect 74: An apparatus for wireless communication, the apparatus comprising at least one means for performing the method of one or more of Aspects 1-71.

Aspect 75: A non-transitory computer-readable medium storing code for wireless communication, the code comprising instructions executable by one or more processors to perform the method of one or more of Aspects 1-71.

Aspect 76: A non-transitory computer-readable medium storing a set of instructions for wireless communication, the set of instructions comprising one or more instructions that, when executed by one or more processors of a device, cause the device to perform the method of one or more of Aspects 1-71.

Aspect 77: A device for wireless communication, the device comprising a processing system that includes one or more processors and one or more memories coupled with the one or more processors, the processing system configured to cause the device to perform the method of one or more of Aspects 1-71.

Aspect 78: An apparatus for wireless communication at a device, the apparatus comprising one or more memories and one or more processors coupled to the one or more memories, the one or more processors individually or collectively configured to cause the device to perform the method of one or more of Aspects 1-71.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a serving cell, a physical downlink control channel (PDCCH) order initiating a random access procedure in a candidate cell;
determine a timing delay associated with a timing difference between the serving cell and the candidate cell; and
transmit a physical random access channel (PRACH) communication to the candidate cell in accordance with the PDCCH order and the timing delay.

2. The apparatus of claim 1, wherein the timing difference is associated with downlink transmission timing difference or a downlink reception timing difference between the serving cell and the candidate cell.

3. The apparatus of claim 1, wherein the PRACH communication is transmitted to the candidate cell in accordance with a latency that is based at least in part on a fixed time delay, a bandwidth part switching delta, the timing delay, and a switching time.

4. The apparatus of claim 1, wherein the PRACH communication is transmitted in a PRACH occasion for which a time between a last symbol of the PDCCH order and a first symbol of the PRACH communication is larger than or equal to a latency that is based at least in part on the timing difference between the serving cell and the candidate cell.

5. The apparatus of claim 1, wherein the one or more processors are further configured to receive a random access response message from the serving cell in accordance with the timing delay.

6. The apparatus of claim 1, wherein the one or more processors are further configured to receive a random access response message from the candidate cell in accordance with the timing delay.

7. An apparatus for wireless communication at a user equipment (UE), comprising:
a memory; and
one or more processors, coupled to the memory, configured to:
receive a cell switch command, associated with a switch from a serving cell to a target cell, that indicates a unified transmission configuration indication (TCI) for the target cell;
obtain configuration information that indicates a beam to use for receiving or transmitting at least one channel or reference signal configured to not use the unified TCI; and
communicate in the target cell in accordance with the configuration information.

8. The apparatus of claim 7, wherein the configuration information indicates that all channels and reference signals in the target cell are to use the unified TCI indicated in the cell switch command.

9. The apparatus of claim 7, wherein the configuration information indicates that a first channel or reference signal is to use the unified TCI indicated in the cell switch command and that a second channel or reference signal is to not use the unified TCI indicated in the cell switch command.

10. The apparatus of claim 7, wherein the one or more processors, to obtain the configuration information, are further configured to receive a non-unified TCI that indicates the beam to use for receiving or transmitting the at least one channel or reference signal configured to not use the unified TCI.

11. The apparatus of claim 10, wherein the non-unified TCI is received prior to the cell switch command, included in the cell switch command, or after the cell switch command.

12. The apparatus of claim 7, wherein the configuration information indicates that a default TCI or a beam indication indicated in the cell switch command is to be used for receiving or transmitting the at least one channel or reference signal configured to not use the unified TCI.

13. The apparatus of claim 12, wherein the default TCI corresponds to a synchronization signal block included in a PRACH.

14. An apparatus for wireless communication at a user equipment (UE), comprising:
a memory; and
one or more processors, coupled to the memory, configured to:
obtain configuration information associated with implicit transmission configuration indication (TCI) activation based at least in part on switching from a first cell to a second cell;
receive a cell switch command that includes an indication to switch from the first cell to the second cell; and
activate a TCI for the second cell in accordance with the configuration information and the cell switch command.

15. The apparatus of claim 14, wherein the configuration information indicates that the TCI that is activated in accordance with the cell switch command is associated with a synchronization signal block indicated in a physical downlink control channel order for measuring a timing advance associated with the second cell.

16. The apparatus of claim 14, wherein the configuration information indicates that the TCI that is activated in accordance with the cell switch command is associated with a synchronization signal block indicated in the cell switch command.

17. The apparatus of claim 14, wherein the configuration information indicates that the TCI that is activated in accordance with the cell switch command is a synchronization signal block included in a beam report associated with the second cell.

18. The apparatus of claim 14, wherein the TCI is activated for the second cell before receiving the cell switch command that includes the indication to switch from the first cell to the second cell based at least in part on a capability of the UE.

19. The apparatus of claim 18, wherein the TCI is activated for the second cell before receiving the cell switch command that includes the indication to switch from the first cell to the second cell based at least in part on the second cell being a special cell.

20. The apparatus of claim 18, wherein the TCI is activated for the second cell before receiving the cell switch command that includes the indication to switch from the first cell to the second cell based at least in part on the second cell being a secondary cell.
